(19) United States
(12) Patent Application Publication
(10) Pub. No.: US 2006/0006363 A1
(43) Pub. Date: Jan. 12, 2006

(54) Electrooptic light control element, electrooptic display and control medium

(76) Inventors: Michael Heckmeier, Hemsbach (DE); Markus Czanta, Darmstadt (DE); Achim Goetz, Alsbach-Haehnlein (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/534,977

(22) PCT Filed: Nov. 5, 2003
(86) PCT No.: PCT/EP03/12327

§ 371 Date: May 16, 2005

(30) Foreign Application Priority Data
Nov. 14, 2002 (DE) 10253325.3

(51) Int. Cl. C09K 19/52; C09K 19/02; C09K 19/30; C09K 19/12; C09K 19/20; G02F 1/133

(52) U.S. Cl. 252/299.01; 349/186; 252/299.63; 252/299.66; 252/299.67; 428/1.1

(57) ABSTRACT

The present invention relates to an electro-optical light modulation element, to electro-optical displays and display systems containing elements of this type, such as, for example, television screens and computer monitors, and to the modulation media used. The light modulation elements according to the invention contain a mesogenic modulation medium which is in an optically isotropic phase during operation of the light modulation elements and, besides good contrast, low viewing-angle dependence and very short response times, are particularly distinguished by relatively low driving voltages. The modulation media according to the invention are distinguished by a combination of large dielectric susceptibility in the optically isotropic phase with small enthalpy of clearing or the occurrence of a blue phase. At a temperature of 4° above the clearing point or conversion temperature (T(N*,BP)), the dielectric susceptibility of the modulation medium is preferably 25 or more and the enthalpy of clearing is 1.50 J/g or less.

### FIELD OF THE INVENTION

The present invention relates to light modulation elements, to displays containing same, and to light modulation media. The light modulation elements preferably use modulation media which have anisotropic properties at certain temperatures, such as, for example, liquid crystals. The light modulation elements are operated at a temperature at which the modulation media are in an optically isotropic phase, preferably in the blue phase or in the isotropic phase. In a preferred embodiment, the light modulation elements are operated at a temperature at which the modulation media are in the blue phase. Light modulation elements which are operated at a temperature at which the modulation media are in the isotropic phase are described in DE 102 17 273.0 and DE 102 41 301.0 of 04.09.2002 (a further patent applications by the applicant of the present application which is hitherto unpublished).

The present invention relates to an electro-optical light modulation element and to electro-optical displays and display systems containing elements of this type, such as, for example, television screens and computer monitors, and to the modulation media used in the light modulation elements. The light modulation elements according to the invention contain a mesogenic modulation medium which is in an optically isotropic phase during operation of the light modulation elements. Besdies good contrast and low viewing-angle dependence of the contrast, they are particularly distinguished by very short response times at the same time as a low operating voltage.

In particular, the present invention relates to mesogenic media and to the use thereof as modulation media in light modulation elements of this type.

### OBJECT AND PRIOR ART

Conventional electro-optical liquid-crystal displays are known in general terms. They are operated at a temperature at which the modulation medium is in a generally anisotropic mesophase. In most display types, the modulation media are used in the nematic phase. In the anisotropic mesophase, the modulation media already have anisotropic properties, such as, for example, birefringence (Δn). This is not only induced just when an electric field is applied. The most widespread are TN (“Twisted nematic”) and STN (“super twisted nematic”) displays. The liquid-crystal cells in these displays have electrodes on the substrates on the two opposite sides of the liquid-crystal medium. The electric field is thus essentially perpendicular to the liquid-crystal layer. The first-mentioned displays in particular are used in combination with TFT (“thin film transistor”) addressing for displays having a large information content and high resolution, for example in laptop and notebook computers. Use has recently increasingly been made, in particular in desktop computer monitors, of liquid-crystal displays of the IPS (“In-plane switching”, for example DE 40 00 451 and EP 0 588 568) type or alternatively of the VAN (“vertically aligned nematic”) type. VAN displays are a variant of the ECB (“electrically controlled birefringence”) displays. In a modern variant, the MVA (“multi domain vertically aligned”) displays, a plurality of domains is stabilised per addressed electrode, and in addition a special optical compensation layer is used. These displays, like the TN displays already mentioned, use an electric field perpendicular to the liquid-crystal layer. In contrast thereto, IPS displays generally use electrodes on only one substrate, i.e. on one side of the liquid-crystal layer, i.e. are characterised by a significant component of the electric field parallel to the liquid-crystal layer.

A common feature of all these conventional displays is relatively slow switching, which is, in particular, inadequate for the ever more widespread TV and multimedia applications. This is particularly striking in comparison with the virtually ubiquitous cathode-ray tubes. A further disadvantage of the known electro-optical effects employed in liquid-crystal displays is the significant viewing-angle dependence of the contrast achieved. In most cases, this is so great that compensation layers, typically anisotropic films, in some cases with a complex structure, have to be used for displays operated with direct viewing.

DE 102 17 273.0 describes light modulation elements in which the mesogenic modulation medium is in the isotropic phase at the operating temperature. These light modulation elements switch particularly quickly and have good viewing-angle dependence of the contrast. However, the driving voltages are too high for many applications. In addition, the temperature dependence of the driving voltages is very great. The demand therefore exists for improved light modulation elements, in particular having a reduced driving voltage.

Unpublished application DE 102 41 301.0 proposes special electrode structures which result in a significant reduction in the operating voltages. However, these electrode structures require considerably more work during production of the light modulation elements.

However, a reduction in the voltages necessary for driving the electro-optical switching elements through correspondingly optimised modulation media does not, in contrast to the electrode structures proposed in DE 102 41 301.0, require more work during production of the light modulation elements.

The present invention thus had the object of developing particularly fast-switching light modulation elements having good viewing-angle dependence and in particular having low driving voltages and low temperature dependence of the driving voltage and providing the modulation media required for this purpose. These light modulation elements should have a layer thickness of the modulation media which is as small as possible in order to be suitable for use as elements of FPDs (flat panel displays), such as, for example, flat panel screens for computers. They should furthermore be addressable by means of an electrode configuration which is as simple as possible and have a low operating voltage with low temperature dependence. In addition, for use in electro-optical displays, they should have good contrast with low viewing-angle dependence.

### PRESENT INVENTION

Surprisingly, it has been found that, as described below, light modulation elements which use modulation media in an optically isotropic phase can be significantly improved and that, in particular, light modulation elements having significantly reduced characteristic voltages can be achieved.

The electro-optical light modulation elements in accordance with the present invention comprise
a substrate or a plurality of substrates,
an electrode arrangement,
at least one element or a plurality of elements for polarisation of the light and
a modulation medium,
   and are characterised in that
the light modulation element is operated at a temperature at which the modulation medium is in an optically isotropic phase in the unaddressed state, and in that
the electrode arrangement can generate an electric field having a significant component parallel to the surface of the mesogenic modulation medium, and in that
the mesogenic modulation medium satisfies at least one of the following conditions (a) and (f) and, in the case where it only satisfies condition (a), it satisfies at least one of the following conditions (b) and (c) and, in the case where it only satisfies condition (c) of conditions (b) and (c), it satisfies at least one of the two further following conditions (d) and (e), and, in the case where it satisfies condition (f), it optionally also satisfies condition (g)
   (a) the modulation medium has, with increasing temperature, a transition from the nematic phase or from the cholesteric phase (Ch, here referred to as the chiral nematic phase N*) into the isotropic phase (T(N,I) or T(N*,I)), i.e. a typical clearing point, and the dielectric susceptibility of the modulation medium at a temperature of 4 degrees above the clearing point is 25 or more,
   (b) the enthalpy of clearing of the modulation medium is 0.78 J/g or less, or
   (c) the enthalpy of clearing of the modulation medium is 1.50 J/g or less, and
      (d) the dielectric susceptibility of the modulation medium at a temperature of 4 degrees above the clearing point is 27 or more, with the proviso that light modulation elements containing modulation media which comprise 8%, 10% or 12% of compound UVZG-3-N are excluded, or

(e) the dielectric susceptibility of the modulation medium at a temperature of 4 degrees above the clearing point is 35.5 or more, with the proviso that light modulation elements containing modulation media having one of the two following compositions 1 and 2 (of Comparative Examples 3 and 4),

| Composition 1 | | | Composition 2 | | |
|---|---|---|---|---|---|
| Com- | | | Com- | | |
| pound # | Abbreviation | Conc./% | pound # | Abbreviation | Conc./% |
| 1 | UZU-3A-N | 12.0 | 1 | UM-3-N | 10.0 |
| 2 | UZU-5A-N | 12.0 | 2 | PYP-3N.F.F | 15.0 |
| 3 | GZU-3A-N | 12.0 | 3 | UZU-3A-N | 12.0 |
| 4 | GZU-4A-N | 11.0 | 4 | GZU-3A-N | 12.0 |
| 5 | GZU-4O-N | 10.0 | 5 | GZU-4-N | 1.0 |
| 6 | UVZG-3-N | 10.0 | 6 | GZU-4O-N | 10.0 |
| 7 | CUZU-2-N | 10.0 | 7 | UVZG-3-N | 10.0 |
| 8 | CUZU-3-N | 10.0 | 8 | CUZU-2-N | 10.0 |
| 9 | CUZU-4-N | 10.0 | 9 | CUZU-3-N | 10.0 |
| 10 | HP-5N.F | 3.0 | 10 | HP-3N.F | 10.0 |

in which the abbreviations for the compounds are as defined below, are excluded,
(f) the modulation medium has, with increasing temperature, a transition from the cholesteric phase into a blue phase (BP) at a temperature T(N*,BP), and
(g) the dielectric susceptibility of the modulation medium at a temperature of 4 degrees above this transition temperature (T(N*,BP)) is 25 or more, preferably 27 or more, particularly preferably 35.5 or more.

The present invention is explained in greater detail below.

Besides the low driving voltage, in particular the contrast of these displays and its viewing-angle dependence is excellent and the response times are very short.

The light modulation elements according to the invention preferably contain a mesogenic medium which is in an optically isotropic phase at the operating temperature. This medium is advantageously located on or below a substrate. The optically isotropic phase can be the isotropic phase or a homogeneous optically isotropic phase, such as a blue phase, or an inhomogeneous optically isotropic phase. The inhomogeneous optically isotropic phase can consist of a system of mesogenic medium and a polymer. The mesogenic medium here can be dispersed in the polymer in the form of droplets (PDLC for “polymer dispersed liquid crystals”) or can be in coherent form (PN for “polymer network”). The size of the dimensions of the characteristic structures (droplet diameter or diameter of the network fibres or meshes) here is in the order of the wavelength of the light used and is preferably smaller than this. The modulation medium preferably has a blue phase at the addressing temperature or at least at one of the addressing temperatures. In a preferred embodiment, this blue phase is a homogeneous phase, i.e. does not comprise any solid (for example polymeric) material.

Preference is given to the use of a modulation medium having a homogeneous phase.

In a preferred embodiment of the present invention, the modulation medium of the light modulation element is in the isotropic phase at the operating temperature or at at least one of the operating temperatures. In a further preferred embodiment of the present invention, the modulation medium of the light modulation element is in a blue phase at the operating temperature or at at least one of the operating temperatures. In this embodiment, the operating temperature range can extend over the blue phase and beyond or, in the case of the occurrence of a plurality of blue phases, over their range and beyond into the isotropic phase.

Liquid crystals having a correspondingly great chiral twist can have one or more optically isotropic mesophases. These phases appear slightly bluish at a corresponding cholesteric pitch, in a sufficiently large layer thickness. For this reason, they are known as blue phases (Gray and Goodby, “Smectic Liquid Crystals, Textures and Structures”, Leonhard Hill, USA, Canada (1984)).

The effects of electric fields on liquid crystals which are in a blue phase are described, for example, in H. S. Kitzerow, “The Effect of Electric Fields on Blue Phases”, Mol. Cryst. Liq. Cryst, (1991), Vol. 202, pp. 51-83. The three types of blue phase (BP I to BP II) identified to date which can be observed in field-free liquid crystals are also mentioned therein. However, electro-optical displays which utilise field-induced birefringence are not described. Under the influence of an electric field, further blue phases or other phases which are different from blue phases I, II and III may arise.

The modulation medium used in the light modulation element is preferably a mesogenic medium. The term mesogenic media in the present application denotes media which have a mesophase, are soluble in a mesophase or induce a mesophase. The mesophase is a smectic or nematic phase, preferably a nematic phase.

In a particularly preferred embodiment, the addressing medium has a blue phase or a plurality of blue phases. The blue phase or the blue phases preferably extends or extend over a temperature range (AT(BP)) having a width of 5° or more, preferably of 10°, particularly preferably of 200 or more and very particularly preferably of 30° or more.

In modulation media which have a typical clearing point, i.e. a transition from the nematic phase or the cholesteric phase into the isotropic phase (T(N,I) or T(N*,I)), the optical anisotropy of the modulation medium at a temperature of 4 degrees below the clearing point is preferably 0.080 or more, and the modulation medium preferably has a clearing point in the range from −30° C. to 80° C., preferably up to 55° C.

The preferred medium used for investigating the mesogenic properties of the materials which do not have a mesophase is nematic mixture ZLI4792 from Merck KGaA, Darmstadt, Germany. The mesogenic materials preferably have a clearing point (T(N,I) or T(N*,I)), extrapolated from a 10% solution in this mixture, of −100° C. or above, particularly preferably of −50° C. or above and very particularly preferably of −20° C. or above.

In general, the modulation medium is located between two substrates. This embodiment is preferred. If the modulation medium is located between two substrates, at least one of these substrates is light-transparent. The light-transparent substrate or the light-transparent substrates may, for example, consist of glass, quartz or plastic. If a non-light-transparent substrate is used, this may consist, inter alia, of a metal or a semiconductor. These media can be used as such or can be located on a support, for example a ceramic. If the modulation medium is a polymeric medium, the use of a second substrate can, if desired, be omitted. Polymeric modulation medium can even be produced in self-supporting form. In this case, no substrate at all is necessary.

The operating temperature of the light modulation element is preferably above the transition temperature of the modulation medium into the optically isotropic phase, in general in the range from 0° to 50° above this transition temperature, preferably in the range from 0.10 to 100 above this transition temperature and particularly preferably in the range from 0.1° to 5° above this transition temperature.

On application of a voltage, an alignment is induced in the mesogenic medium in the optically isotropic phase which results in optical retardation, which can be visualised in a known manner. An inhomogeneous electric field is preferably used.

The light modulation elements according to the invention contain at least one element for polarisation of the light. In addition, they preferably contain a further optical element. This further optical element is either a second element for polarisation of the light, a reflector or a transflector.

The optical elements are arranged in such a way that the light, on passing through the mesogenic medium of the light modulation element, passes at least once through at least one polarising element both before entering the mesogenic medium and after exiting from the mesogenic medium.

In a preferred embodiment of the light modulation element in accordance with the present invention, the mesogenic medium is located between two polarisers, i.e. a polariser and an analyser. Two linear polarisers are preferably used. In this embodiment, the absorption axes of the polarisers are preferably crossed and preferably form an angle of 90°.

The light modulation element according to the invention optionally contains one or more birefringent layers. It preferably contains one λ/4 layer or a plurality of λ/4 layers, preferably one λ/4 layer. The optical retardation of the λ/4 layer is preferably about 140 nm.

The layer thickness (d) of the mesogenic modulation medium is preferably 0.1 μm to 5000 μm (i.e. 5 mm), particularly preferably 0.5 μm to 1000 μm (i.e. 1 mm), particularly preferably 1.0 μm to 100 μm and very particularly preferably 3.0 μm to 30 μm and in particular 3.5 μm to 20 μm. In a preferred embodiment, the layer thickness of the mesogenic modulation medium is preferably 0.5 μm to 50 μm, particularly preferably 1.0 μm to 20 μm and very particularly preferably 1.0 μm to 8.0 μm.

The present invention also relates to electro-optical displays which contain one or more light modulation elements according to the invention. These electro-optical displays are preferably addressed by means of an active matrix.

The present invention furthermore relates to electro-optical display systems containing one or more electro-optical displays according to the invention. These electro-optical display systems are preferably used for the display of information, inter alia preferably as a television screen or as a computer monitor. The information to be displayed is preferably digital signals or video signals.

The light modulation element according to the invention may additionally contain one or more further conventional optical elements, such as birefringent layers (for example compensation layers), diffuser layers and elements for increasing the brightness and/or the light yield and/or the viewing-angle dependence, this list not being definitive.

The light modulation elements according to the invention are characterised by good contrast, which is highly and virtually predominantly dependent on the properties of the polarisers used. For comparison with conventional TN cells, the TN cells used here have an optical retardation of 0.50 μm, positive contrast and the absorption axis of the polarisers perpendicular to the preferential alignment of the nematic liquid crystals at the adjacent substrate and contain non-chiral liquid crystals. If the same polarisers are used in the light modulation elements according to the invention and in these conventional TN cells, the contrast of the light modulation elements according to the invention is about 40% or more greater than that of the TN cells.

The viewing-angle dependence of the contrast of the light modulation elements according to the invention is very good. It is significantly better than that of the known ECB cells. It is more comparable with the viewing-angle dependence observed in commercially available IPS displays (for example from Hitachi and NEC, both Japan) and MVA displays (for example from Fujitsu, Japan). It is much lower than that of conventional TN displays.

Thus, an isocontrast curve for a given contrast ratio in the light modulation elements according to the invention generally includes a range of angles which is more than twice as large, often even more than three times as large, as the corresponding range of angles of an isocontrast curve for the same contrast ratio in the TN display.

The response times of the light modulation elements according to the invention are very small. They are generally at values of 5 ms or less, preferably at 1 ms or less, preferably at 0.5 ms or less, particularly preferably at 0.1 ms or less.

It is particularly advantageous that, on switching between different grey shades, both the response time for switching off and also, particularly surprisingly, that for switching on are virtually independent of the driving voltage used. This represents a significant advantage over conventional light modulation elements, such as liquid-crystal cells, for example TN cells.

The electro-optical characteristic line was characterised by characteristic voltages. To this end, use was made, in particular, of the voltages at which 10%, 50% and 90% relative contrast is achieved. These voltages (V₁₀, V₅₀ and V₉₀ for short) are also known as the threshold, mid-grey and saturation voltage respectively. In addition, the voltage at which 70% relative contrast is achieved (V₇₀) was generally determined.

Electro-optical displays in accordance with the present invention contain one or more light modulation elements according to the invention. In a preferred embodiment, these are addressed by means of an active matrix.

In another preferred embodiment, the light modulation elements according to the invention are addressed in so-called “field sequential mode”. Here, the switching elements are illuminated successively with light of different colours synchronously with the addressing. In order to produce the pulsed coloured light, a colour wheel, stroboscope lamps or flash lamps, for example, can be employed.

Electro-optical displays in accordance with the present invention may, in particular if they are used for television screens, computer monitors or the like, contain a colour filter for the display of coloured images. This colour filter advantageously consists of a mosaic of filter elements of different colours. Typically here, an element of the colour filter mosaic of a colour is assigned to each electro-optical switching element.

The light modulation elements according to the invention comprise an electrode structure which generates an electric field having a significant component parallel to the layer of the mesogenic medium. This electrode structure may be designed in the form of interdigital electrodes. It may be designed in the form of combs or ladders. Embodiments in the form of superimposed “H”s and double “T”s or “I”s are also advantageous. The electrode structure is advantageously located on only one side of the mesogenic medium, on use of at least one substrate preferably between this and the mesogenic medium. The electrode structure is preferably located in at least two different planes, both located on one side of the mesogenic modulation medium; this applies in particular if the electrode structure contains superjacent sub-structures. These sub-structures are advantageously separated from one another by a dielectric layer. If the sub-structures are located on opposite sides of an insulation layer, a layout can be selected which allows the creation of capacitors. This is particularly advantageous in the case of addressing of displays by means of an active matrix. Active-matrix displays of this type use a matrix of driving elements having a non-linear current/voltage characteristic line which are assigned to the individual light modulation elements, such as, for example, TFTs or MIM (metal insulator metal) diodes.

An essential aspect of the present invention consists in the design of the electrode structure of the electro-optical switching elements according to the invention. Various embodiments are possible here. The preferred embodiments of the electrodes of the light modulation elements according to the invention are described below, where appropriate with reference to the corresponding figures.

The construction of light modulation elements with a mesogenic modulation material is described in principle in DE 102 172 73.0. It is illustrated briefly here with reference to FIG. 1.

The figure shows diagrammatically a cross section of the construction of a switching element or part of a switching element in accordance with DE 102 172 73.0. The modulation medium (2) is located between the inner surfaces of the substrates (1) and (1′). The two electrodes (3) and (4) of the electrode structure, to which different potentials can be applied, are located on the inner surface of one substrate (1). “Vop” denotes the source of the voltage, charge or current. The lines emanating from Vop symbolise the electric supply lines to the electrodes.

The electrodes can consist of transparent material, such as, for example, indium tin oxide (ITO). In this case, it may be advantageous and sometimes necessary to cover a part or parts of the light modulation element by means of a black mask. This allows areas in which the electric field is not effective to be masked off and the contrast thus to be improved. However, the electrodes can also consist of non-transparent material, usually of metal, for example of chromium, aluminium, copper, silver or gold, preferably of chromium. In this case, the use of a separate black mask may be superfluous.

The electric field used is preferably an inhomogeneous field.

It has been found that the mutual lateral separation of the electrodes to which a different potential can be applied has a considerable influence on the characteristic voltages of the light modulation elements. With decreasing separation, the driving voltage required decreases. However, if the separation becomes smaller, the relative aperture of the light modulation element also becomes smaller and the brightness decreases. The electrodes preferably have a mutual separation which is in the range from 0.5 μm to 100 μm, preferably in the range from 1 μm to 20 μm, particularly preferably in the range from 1 μm to 15 μm, very particularly preferably in the range from 2 μm to 12 μm and most preferably in the range from 3 μm to 11 μm. The mutual separation of the electrodes is preferably 19 μm or less, particularly preferably 15 μm or less, very particularly preferably 10 μm or less and especially preferably 9 μm or less.

The width of the electrodes in the direction of the adjacent electrodes to which a different potential can be applied is less critical than the separation of the electrodes in this direction. It has virtually no effect on the characteristic voltages of the light modulation elements. With increasing width of the electrodes, however, the relative aperture of the light modulation element becomes smaller and the brightness decreases, in particular if the electrodes consist of material which is not transparent to light. With decreasing width of the electrodes, by contrast, its electrical resistance increases. The electrodes preferably have a width in the range from 0.5 μm to 30 μm, preferably in the range from 0.5 μm to 20 μm, particularly preferably in the range from 0.7 μm to 19 μm, very particularly preferably in the range from 1 μm to 9 μm and most preferably in the range from 1.5 μm to 6 μm.

In a preferred embodiment of the present invention, the mesogenic media have a nematic phase or a cholesteric. However, it is also possible to use media in which the temperature range of the nematic phase or cholesteric phase is so narrow that a transition virtually takes place from the crystalline phase or from the smectic phase into the optically isotropic phase. This optically isotropic phase is preferably a blue phase, but can also be the isotropic phase. In some embodiments, the temperature range of the blue phase is relatively narrow and extends only over a few degrees or less.

The clearing point of the modulation media which have a transition from the nematic phase or the cholesteric phase into the isotropic phase (T(N,I) or T(N*,I)) and the conversion temperature (T(N*,BP)) of the media which have a blue phase is preferably in the range from −20° C., preferably from −30° C. to 80° C., preferably up to 60° C., particularly preferably in the range from 0° C. to 60° C., preferably up to 55° C. and very particularly preferably in the range from 20° C. to 60° C., preferably up to 50° C. In displays having backlighting, the clearing point or the conversion temperature is preferably in the range from 10° C. to 70° C. and particularly preferably in the range from 30° C. to 50° C.

In the embodiment in which the modulation media have a typical clearing point (T(N,I) or T(N*,I)), the nematic phase is preferably stable down to low temperatures of down to −10° C., particularly preferably down to −30° C. and very particularly preferably down to −40° C. According to the investigations on which the present application is based, the modulation media in this embodiment have an enthalpy of clearing which is as low as possible, i.e. an enthalpy (ΔH) for the transition from the mesophase, preferably from the nematic or cholesteric phase, into the isotropic phase. The enthalpy of clearing is preferably 1.50 J/g or less, particularly preferably 1.00 J/g or less and very particularly preferably 0.80 J/g or less.

In a particularly preferred embodiment of this embodiment of the present invention, the modulation media have an enthalpy of clearing of less than 0.90 J/g, preferably of 0.78 J/g or less, particularly preferably of 0.70 J/g or less and very particularly preferably of 0.60 J/g or less and in particular of 0.55 J/g or less.

Furthermore, the inventors of the present invention have found that the modulation media in this embodiment, in which the modulation media have a typical clearing point (T(N,I) or T(N*,I)), should have a dielectric susceptibility (E, also referred to as E.) which is as large as possible. At a temperature of 4° above the clearing point of the medium, the dielectric susceptibility is 25 or more, preferably 27 or more, preferably 35.5 or more, preferably 36 or more, particularly preferably 40 or more and very particularly preferably 55 or more, or 60 or more.

The optical anisotropy of the medium at a temperature of 4° below the clearing point of the medium is, in this preferred embodiment, in which the modulation media have a typical clearing point (T(N,I) or T(N*,I)), preferably 0.080 or more, particularly preferably 0.090 or more and very particularly preferably 0.100 or more.

In a particularly preferred embodiment of this preferred embodiment, in which the modulation media have a typical clearing point (T(N,I) or T(N*,I)), the mesogenic media in accordance with the present invention preferably have a birefringence (Δn), in the nematic phase at a temperature of 4 degrees below the clearing point, of 0.150 or more and particularly preferably of 0.200 or more. The value of the birefringence is as good as unlimited for the application according to the invention. In practical terms, however, it is generally 0.500 or less and usually 0.450 or less in this preferred embodiment, in which the modulation media have a typical clearing point (T(N,I) or T(N*,I)). The value of the birefringence of the media according to the invention is measured here in the nematic phase at a temperature of 40 below the clearing point.

If the medium is not nematically stable at this temperature or at least not supercoolable down to this temperature in the nematic phase, the birefringence of a mixture of the medium and nematic mixture ZLI4792 from Merck KGaA is, as in the case of individual substances and premixes, determined at 20° C. and extrapolated to the value of the pure medium from the change compared with mixture ZLI4792.10% of the medium and 90% of mixture ZLI4792 are used. If the solubility of the medium is not sufficient, the concentration is changed to 5%, and if the solubility then is still not sufficient, the host mixture used is nematic mixture MLC-6828, as described further below, and if necessary the concentration here is also reduced from 10% to 5%. The method of extrapolation of the values from the host mixture is used for all corresponding properties of the media, if these cannot be investigated in the nematic phase at the corresponding temperature.

In a further preferred embodiment, the modulation medium has a blue phase, i.e. the medium undergoes a transition from the nematic phase, a smectic phase or the crystalline phase into a blue phase with increasing temperature. The medium can have a plurality of blue phases with increasing temperature. With further increasing temperature, the medium undergoes a transition into the isotropic phase at a transition temperature (T(BP,I)).

In this embodiment, the transition temperature (T(BP,I)) is preferably in the range from −20° C., preferably from −30° C. to 80° C., preferably up to 60° C., particularly preferably in the range from 0° C. to 60° C., preferably up to 55° C. and very particularly preferably in the range from 20° C. to 60° C., preferably up to 50° C. In displays with backlighting, the clearing point is preferably in the range from 10° C. to 70° C. and particularly preferably in the range from 30° C. to 50° C.

In this embodiment, the dielectric susceptibility (s) of the modulation medium at a temperature of 40 above the transition temperature (T(BP,I)) of the medium is 25 or more, preferably 27 or more, preferably 35.5 or more, preferably 36 or more, particularly preferably 40 or more and very particularly preferably 55 or more, or 60 or more.

The mesogenic media in accordance with the present invention preferably have a dipole moment of 4 debyes or more, particularly preferably of 6 debyes or more and particularly preferably of 8 debyes or more.

For the light modulation elements in accordance with the present invention, both mesogenic modulation media which have positive dielectric anisotropy (Δε) in the mesophase and those which have negative dielectric anisotropy can be used. Preference is given to the use of mesogenic modulation media which have positive dielectric anisotropy (Δε) in the anisotropic mesophase, preferably in the nematic phase.

If the mesogenic modulation media have positive dielectric anisotropy, this preferably has a value of 15 or more, particularly preferably 30 or more and very particularly preferably 45 or more, in the modulation media which have a transition from the nematic phase or from the cholesteric phase into the isotropic phase at 1 kHz and a temperature of 4° below the clearing point, preferably in the nematic phase. If the medium does not have a nematic phase, or if it is not in the nematic phase at a temperature of 4° below the transition into the isotropic phase, its dielectric anisotropy, like the birefringence, is determined by extrapolation of the values of a corresponding host mixture.

If the mesogenic modulation media have negative dielectric anisotropy, this preferably has a value of −5 or less, particularly preferably −7 or less and very particularly preferably −10 or less, in the modulation media which have a transition from the nematic phase or from the cholesteric phase into the isotropic phase at 1 kHz and a temperature of 40 below the clearing point, preferably in the nematic phase. For dielectrically negative modulation media, nematic mixture ZLI-3086 from Merck KGaA is used, if necessary, as host mixture, as for dielectrically negative compounds.

The corresponding limits for AE also apply to media which have a transition T(N*,BP). They then relate to a temperature of 4° below this temperature. Particular preference is given to modulation media having positive dielectric anisotropy.

The modulation media according to the invention in the light modulation elements according to the invention preferably have a characteristic voltage V₇₀ in the range from 5 V to 150 V, preferably from 15 V to 110 V, particularly preferably from 20 V to 90 V and very particularly preferably from 30 V to 80 V, at a temperature of 2 degrees above the clearing point (T(N,I) or T(N*,I)) or the transition temperature (T(N*,BP)). The modulation media according to the invention in the light modulation elements according to the invention particularly preferably have a characteristic voltage of 105 V or less, preferably of 95 V or less, particularly preferably of 75 V or less and very particularly preferably of 65 V or less, at a temperature of 2 degrees above the clearing point or the transition temperature.

The modulation media according to the invention in the light modulation elements according to the invention preferably have low temperature dependence of the characteristic voltage V₇₀ at a temperature of 2 degrees above the clearing point (T(N,I) or T(N*,I)) or the transition temperature (T(N*,BP)), i.e. dV/dT(T(N,I)+2°) or dV/dT(T(N*,I)+2°) or dV/dT(T(N*,BP)+20), over a temperature range from one degree below to one degree above the given temperature, in the range from 1 via to 20 V/°, preferably from 1 V/° to 15 V/°, particularly preferably from 2 V/° to 10 via and very particularly preferably from 2 V/° to 7 V/°. This applies in particular to the media which have a transition from the nematic or cholesteric phase into the isotropic phase.

In a particularly preferred embodiment, the modulation media according to the invention in the light modulation elements according to the invention have an even low temperature dependence of the characteristic voltage V₇₀ at a temperature of 2 degrees above the clearing point (T(N,I) or T(N*,I)) or the transition temperature (T(N*,BP)), i.e. dV/dT(T(N,I)+2°) or dV/dT(T(N*,I)+20) or dV/dT(T(N*,BP)+20), over a temperature range from one degree below to one degree above the given temperature. This is in the range from 0 V/° to 5 V/°, preferably from 0 V/° to 3/V°, particularly preferably from 0 V/° to 1 V/° and very particularly preferably from 0.1 V/° to 0.8 V/°. This applies in particular to the media which have a transition from the cholesteric phase into the blue phase.

The mesogenic media in accordance with the present invention preferably consist of two to 40 compounds, particularly preferably five to 30 compounds and very particularly preferably seven to 25 compounds.

The mesogenic media according to the invention having positive dielectric anisotropy in accordance with the present invention preferably comprise
a component A consisting of one or more compounds having a very strongly positive dielectric anisotropy of 30 or more,
optionally a component B consisting of one or more compounds having a strongly positive dielectric anisotropy of 10 to <30,
optionally a component C consisting of one or more compounds having a moderately positive dielectric anisotropy of >1.5 to <10,
optionally a component D consisting of one or more dielectrically neutral compounds having a dielectric anisotropy in the range from −1.5 to +1.5, and
optionally a component E consisting of one or more compounds having a negative dielectric anisotropy of less than −1.5.

Component A in these media preferably comprises one or more compounds of the formula I and particularly preferably consists predominantly and very particularly preferably virtually completely of one or more compounds selected from the compounds of the formulae I and II 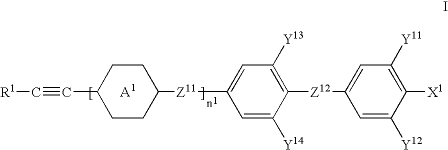
in which
R¹ denotes alkyl having 1 to 7 C atoms or oxaalkyl having 2 to 7 C atoms, each preferably having 2 to 5 C atoms, preferably alkyl, 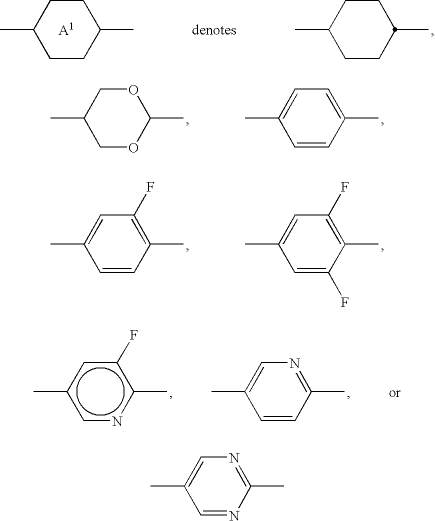
Z¹¹ and Z¹² each, independently of one another, denote a single bond, —CO—O—, trans —CH═CH—, —CH═CF—, —CF═CH—, —CF═CF—, —CH═CH—CO—O—, —CF═CF—CO—O—, —CF═CH—CO—O—, —CH═CF—CO—O—, —CF₂—O—, —O—CF₂— or —C≡C— or a combination of two or more of these groups, preferably at least one of these groups denotes —COO— or —CF₂—O—,
X¹ denotes F, Cl, NO₂, —OCF₃, —CF₃, —OCF₂H, Cl, CN, —C≡C—CN or NCS, preferably CN, —CF₃, —C═C—CN or NCS, particularly preferably CN or —CF₃,
Y¹¹, Y¹², Y¹³ and Y¹⁴ each, independently of one another, denote H or F, and
n¹ denotes 0 or 1, preferably 0,
   where the compounds of the formula I preferably carry three or more, particularly preferably four or more, fluorine atoms on the phenyl rings, but preferably not more than two F atoms per phenyl ring; Y¹¹, Y¹² and Y¹³ particularly preferably denote F and Z¹² preferably denotes —COO—, 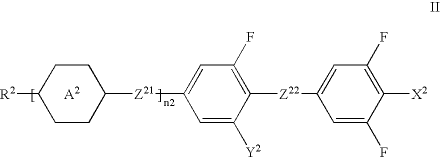
   in which
R² denotes alkyl or alkoxy having 1 to 7 C atoms, alkenyl, alkenyloxy or oxaalkyl having 2 to 7 C atoms, preferably alkyl or alkoxy having 1 to 5 C atoms or alkenyl having 2 to 5 C atoms, preferably alkyl or alkoxy, 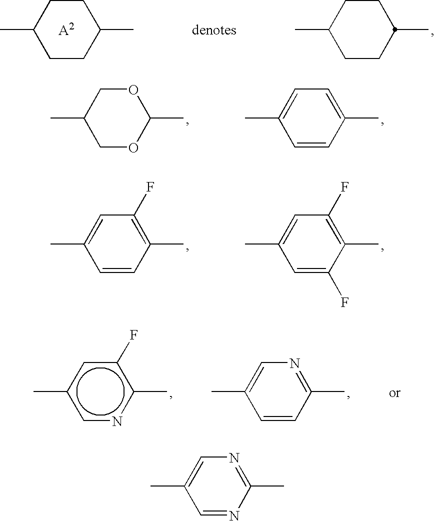
Z²¹ and Z²² each, independently of one another, denote a single bond, —CO—O—, trans —CH═CH—, —CH═CF—, —CF═CH—, —CF═CF—, —CH═CH—CO—O—, —CF═CF—CO—O—, —CF═CH—CO—O—, —CH═CF—CO—O—, —CF₂—O—, —O—CF₂— or —C≡C— or a combination of two or more of these groups, preferably at least one of these groups denotes —COO— or —CF₂—O—,
X² denotes F, Cl, NO₂, —OCF₃, —CF₃, —OCF₂H, Cl, CN, —C≡C—CN or NCS, preferably CN, —CF₃, —C≡C—CN or NCS, particularly preferably CN,
Y² denotes H or F, and
n² denotes 0 or 1.

In a preferred embodiment of the present application, the media comprise one or more compounds of the formula I and preferably consist predominantly and particularly preferably virtually completely of one or more compounds of the formula I.

The compounds of the formula I are preferably selected from the group consisting of the compounds I-1 and I-2 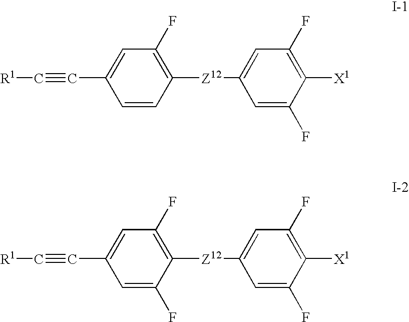
in which the parameters are as defined above under the formula I, and preferably
R¹ denotes alkyl having 1 to 7, preferably having 1 to 5, preferably up to 3, C atoms,
Z¹² denotes —COO— or —CF₂—O—, and
X¹ denotes CN, —CF₃ or NCS, preferably CN or —CF₃.

The-media according to the invention particularly preferably comprise one or more compounds of the formula I, preferably of the formula I-1 and/or of the formula I-2, in which X¹ denotes CF₃.

The compounds of the formula II are preferably selected from the group consisting of the compounds II-1 to II-7 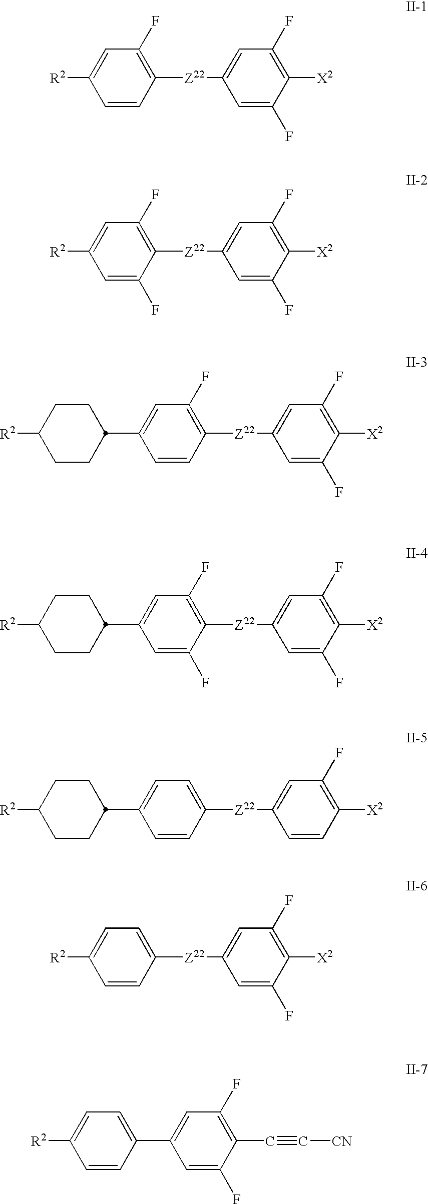
in which the parameters are as defined above under the formula II, and preferably
R² denotes alkyl or alkoxy having 1 to 7 C atoms, alkenyl, alkenyloxy or oxaalkyl having 2 to 7 C atoms, preferably alkyl or alkoxy having 1 to 5 C atoms,
Z²² denotes a single bond, —CO—O— or —CF₂—O—, preferably —COO— or —CF₂—O—,
   in the case of the formula II-6 also particularly preferably —C≡C—, and
X² denotes CN or CF₃, preferably CF₃,
   in the case of the formula II-6 particularly preferably CN or CF₃, preferably CN.

The media according to the invention preferably comprise one or more compounds selected from the group consisting of the compounds of the formulae II1 to II-5, preferably compounds in which Z²² denotes —CO—O—.

In a preferred embodiment of the present invention, component A in the media according to the invention preferably comprises one or more compounds of the formula II and particularly preferably consists predominantly and very particularly preferably virtually completely of one or more compounds of the formula II.

For the light modulation elements in accordance with the present invention, both mesogenic modulation media which have positive dielectric anisotropy (Δε) in the mesophase, preferably in the nematic phase, and those which have negative dielectric anisotropy can be used. Preference is given to the use of mesogenic modulation media which have positive dielectric anisotropy (Δε) in the mesophase. If the mesogenic modulation media have positive dielectric anisotropy, this preferably has a value of 40 or more in the modulation media which have a transition from the nematic phase or from the cholesteric phase into the isotropic phase, at 1 kHz and a temperature of 40 below the clearing point, preferably in the nematic phase.

The mesogenic media in accordance with the present invention having positive dielectric anisotropy particularly preferably consist predominantly and very particularly preferably virtually completely of component A.

In a preferred embodiment, the mesogenic media in accordance with the present invention having positive dielectric anisotropy comprise one or more components selected from the group consisting of components B to D, preferably selected from the group consisting of components B and D, particularly preferably of component B.

The mesogenic media in accordance with the present invention having positive dielectric anisotropy preferably comprise
5% to 80%, preferably 10% to 60%, particularly preferably 18% to 43%, of one or more compounds of the formula I,
5% to 95%, preferably 15% to 80%, particularly preferably 40% to 70%, of one or more compounds of the formula II, and
0% to 30%, preferably 0% to 15%, particularly preferably 0% to 10%, of one or more further compounds.

The mesogenic media in accordance with the present invention having positive dielectric anisotropy preferably comprise
3% to 45%, preferably 5% to 40%, particularly preferably 10% to 35%, of one or more compounds of the formula I-1 and/or
2% to 35%, preferably 4% to 30%, particularly preferably 5% to 30%, of one or more compounds of the formula I-1 and/or
0 to 30%, preferably 2% to 25%, particularly preferably 5% to 20%, of one or more compounds of the formula II-1 and/or
0 to 30%, preferably 2% to 25%, particularly preferably 5% to 20%, of one or more compounds of the formula II-2 and/or
5% to 70%, preferably 15% to 65%, particularly preferably 20% to 60%, of one or more compounds of the formula II-3 and/or II-4, preferably II-4, and/or
0% to 20% preferably 0% to 15%, particularly preferably 3% to 12%, of one or more compounds of the formula II-5 and/or
0% to 30% preferably 0% to 20%, particularly preferably 3% to 15%, of one or more compounds of the formula II-6 and/or
0% to 35% preferably 0% to 30%, particularly preferably 3% to 12%, of one or more compounds of the formula II-7.

The mesogenic media in accordance with the present invention having negative dielectric anisotropy particularly preferably consist predominantly and very particularly preferably virtually completely of component D.

Component D in these media preferably comprises one or more compounds. The mesogenic media having negative dielectric anisotropy in accordance with the present invention preferably comprise
a component A′ consisting of one or more compounds having a strongly negative dielectric anisotropy of −5 or less,
optionally a component B′ consisting of one or more compounds having a moderately negative dielectric anisotropy of −1.5 to <−5,
optionally a component C′ consisting of one or more dielectrically neutral compounds having a dielectric anisotropy of −1.5 to +1.5, and
optionally a component D′ consisting of one or more compounds having a positive dielectric anisotropy of greater than 1.5.

The mesogenic medium in accordance with the present invention may comprise further additives and chiral dopants in the usual concentrations. The total concentration of these further constituents is in the range from 0% to 10%, preferably in the range from 0.1% to 6%, based on the entire mixture. The concentrations of the individual compounds of these are in the range from 0.1 to 3%. The concentration of these compounds and similar constituents of the mixture are, with the exception of the chiral dopants in the case of the media which have a blue phase, not taken into account when specifying the concentration ranges of the other mixture constituents.

The media are obtained in the usual manner from the compounds. The compounds employed in smaller amount are advantageously dissolved in the compounds employed in larger amounts. If the temperature during the mixing operation is increased above the clearing point of the predominant component, the completeness of the dissolution can easily be observed. However, the media according to the invention can also be prepared in other ways, for example by using premixes. Premixes which can be employed are, inter alia, homologue mixtures and/or eutectic mixtures. However, the premixes may also already be usable media themselves. This is the case in so-called two-bottle or multibottle systems.

In the present application, the following applies, unless explicitly stated otherwise.

The indicated ranges of values preferably include the limit values.

The concentrations are given in % by weight and are based on the complete mixture. Temperatures are given in degrees Celsius and temperature differences in differential degrees Celsius. All physical properties were determined as in “Merck Liquid Crystals, Physical Properties of Liquid Crystals”, version of November 1997, Merck KGaA, Germany, and are indicated for a temperature of 20° C., unless explicitly stated otherwise. The optical anisotropy (Δn), also known as the birefringence, is determined at a wavelength of 589.3 nm. The dielectric properties are determined at a frequency of 1 kHz.

In connection with details on the composition of the media or their components,
“comprise” means that the concentration of the said material in each case, i.e. of the component or of the compound, in the reference unit, i.e. the medium or the component, is preferably 10% or more, particularly preferably 20% or more and very particularly preferably 30% or more,
“consist predominantly of” means that the concentration of the said material in the reference unit is preferably 50% or more, particularly preferably 60% or more and very particularly preferably 70% or more, and
“consist virtually completely of” means that the concentration of the said material in the reference unit is preferably 80% or more, particularly preferably 90% or more and very particularly preferably 95% or more.

Dielectrically positive compounds have a As of 1.5, dielectrically neutral compounds have a As in the range −1.5≦Δε≦1.5 and dielectrically negative compounds have a Δε<−1.5. The same definitions also apply to components of mixtures and to mixtures.

The dielectric properties, electro-optical properties (for example the threshold voltages) and the response times were determined in test cells produced at Merck KGaA, Darmstadt, Germany. The test cells for the determination of Δε had a layer thickness of 22 μm and a circular electrode of indium tin oxide (ITO) having an area of 1.13 cm² and a protective ring. For homeotropic alignment for the determination of ε_{∥}, cells having a homeotropically aligning polyimide alignment layer were used. Alternatively, lecithin (Merck KGaA) can be used as alignment agent. The cells for the determination of E had alignment layers of the polyimide AL-1054 from Japan Synthetic Rubber, Japan. The capacitances were generally measured using a Solatron 1260 frequency analyser with a rectangular wave and an effective voltage of 0.3 Vᵣₘₛ. The electro-optical investigations were carried out with white light. The characteristic voltages were determined with perpendicular observation.

The dielectric properties of the materials are determined at 1 kHz and 20° C., and, for modulation media which have a transition from the nematic phase or the cholesteric phase into the isotropic phase (T(N,I)), at a temperature of 40 below and at a temperature of 4° above the clearing point (T(N,I) or T(N*,I)), again in each case at 1 kHz, and, in the case of modulation media which have a transition from the blue phase into the isotropic phase, at a temperature of 40 above the corresponding transition temperature (T(N*,BP)) of the particular material, but in this case at 30 Hz.

The dielectric anisotropy (Δε) of the compounds is determined by extrapolation of the values of a 10% solution of the respective compound in a host mixture at 20° C. to a proportion of the respective compound of 100%. The capacitances of the test mixtures are determined both in a cell having homeotropic edge alignment and in a cell having homogeneous edge alignment. The layer thickness of the two cell types is about 20 μm. The measurement is carried out using a rectangular wave having a frequency of 1 kHz and an effective voltage (rms, root mean square) of typically 0.2 V to 1.0 V. In each case, the voltage used is lower than the capacitive threshold of the mixture investigated in each case.

For dielectrically positive compounds, mixture ZLI-4792 is used and for dielectrically neutral and dielectrically negative compounds, mixture ZLI-3086, both from Merck KGaA, Germany, is used as host mixture. These host mixtures are also used for components and media which do not have a nematic phase even at the relevant temperature or cannot be supercooled down to the relevant temperature in the nematic phase. If the solubility of the compounds, components or media in the respective host mixture is less than 10%, the concentration of the substance investigated is exceptionally reduced to 5%. If the solubility of a dielectrically positive substance (a compound, a component of a medium or a medium) in host mixture ZLI-4792 is less than 5%, nematic mixture MLC-6828, Merck KGaA, Germany, is used as host mixture. Here too, the concentration of the substance to be investigated is, if necessary, halved from 10% to 5%. The value of the pure substance is extrapolated from the change in the values compared with those of the host mixture.

The media according to the invention preferably comprise 0% to 10% of compounds whose solubility in the corresponding host mixture (ZLI-3086 or MLC-6828) is less than 5%. The concentration of these compounds is preferably 8% or less, particularly preferably 5% or less and very particularly preferably 4% or less.

The dielectric anisotropy of the compounds, components and, if desired, the media which are not in the nematic phase at 20° C. or at a temperature of 40 below its clearing point (T(N,I) or (T(N*,I) or their transition temperature (T(N*,BP)) or cannot be supercooled down to this temperature in this phase, are determined from a host mixture as described above in the case of the compounds.

The dielectric constants ε_{∥} and ε [symbol] are determined with an absolute accuracy of about +/−0.1 to +/−0.2, which gives an absolute accuracy of about +/−0.2 to +/−0.4, typically +/−0.3, for the dielectric anisotropy (As). The accuracy drops at larger values, i.e. the possible deviations increase. At values of Δε of 25 to 40, the absolute accuracy is about +/−0.5, and at values of greater than 40, the absolute accuracy is about +/−1.0.

The dielectric susceptibility of the media is determined in the optically isotropic phase at a temperature of 40 above the temperature of their transition into the optically isotropic phase. It is referred to as the average dielectric susceptibility (ε_{av.}). In the media which have a transition from the nematic phase or the cholesteric phase into the isotropic phase, it can also be obtained, to a first approximation, from extrapolation of the average dielectric susceptibility of the nematic medium beyond the transition point into the optically isotropic phase. The dielectric susceptibility of the media is typically determined with an absolute accuracy of about +/−0.1 to +/−0.2. In the case of large values of the dielectric susceptibility, of 30 or more, the absolute accuracy is about +/−0.5, and in the case of very large values, of 40 or more or even of 60 or more, the absolute accuracy is about +/−1.

For the modulation media which have a transition from the nematic phase or the cholesteric phase into the isotropic phase, the enthalpy of clearing was determined by differential scanning calorimetry, DSC for short. To this end, a commercially available DSC2920 instrument from Texas Instruments, USA, was used. 2 mg to 8 mg, typically 4 mg, of the relevant material were measured in a crucible against an empty crucible as reference. The temperature was increased at a heating rate of 10 degrees/minute. The starting point selected was about 30° to 40° below the clearing point of the substance. The end point was in each case about 30° above the clearing point of the substance. The relative accuracy of the values is in each case about +/−10% to +/−15%. At very small values of the enthalpy of clearing, it may be necessary to increase the amount of sample or change to a more accurate measuring instrument.

The value of the birefringence of the media according to the invention is measured here in the nematic phase at 20° C. and at a temperature of 40 below the clearing point or the transition temperature T(N*,BP). If this medium is not nematically stable at one of these two temperatures or at these two temperatures or at least cannot be supercooled down to this temperature in the nematic phase, the birefringence of a mixture is extrapolated from the corresponding nematic host mixture, as described above for the determination of the dielectric anisotropy.

If the cholesteric pitch of the media according to the invention is too short to allow determination of the anisotropic properties, such as, for example, the birefringence or the dielectric susceptibility, three possibilities are available for this purpose. The first, most preferred possibility is replacement of the or all of the chiral compounds used in the media by their racemate. The second, likewise still preferred possibility is reduction in the concentration of the chiral compound or chiral compounds to a value which allows the cholesteric pitch to become so large that determination of the properties is just possible. The third, least preferred possibility is compensation of the cholesteric pitch by addition of a chiral compound having the opposite direction of rotation of the helix. To this end, the corresponding compound of the enantiomer pair R-8011 and S-8011 from Merck KGaA is preferably used.

The term threshold voltage in the present application denotes the optical threshold and is indicated for a relative contrast of 10% (V₁₀). The mid-grey voltage and the saturation voltage are likewise determined optically and indicated for a relative contrast of 50% and 90% respectively. The reference quantity and characteristic value of the electro-optical characteristic line of the various media which are indicated in the present application are generally the voltage (V₇₀) at which the characteristic line reaches the value of 70% relative contrast for the first time. If the capacitive threshold voltage (V₀), also known as the Freedericks threshold, is indicated, this is noted explicitly.

The media were introduced into test cells with interdigital electrodes. The layer thickness of the test cells was generally about 10 μm. The width of the electrodes was 10 μm and the separation between the adjacent electrodes was 15 μm. The electro-optical characteristic line was determined at a temperature of 20 above the clearing point (T(N,I) or T(N*,I)) or the transition temperature from the cholesteric phase into the blue phase (T(N*,BP)) of the respective medium. During introduction of the media into a cell, a slight increase in the clearing point or transition temperature T(N*,BP) was observed in some cases. This effect may be explained by a certain stabilisation of the nematic phase or the blue phase in thin layers. The increase in the clearing point or the transition temperature T(N*,BP) was in some cases 0.5° and up to about 0.7°. In some (rare) cases, deviations of up to 2° or even 4° may occur. In the cases where an increase in the clearing point or the transition temperature T(N*,BP) occurs in the cell, the investigation of the electro-optical properties is not determined at a temperature of 2° above the clearing point of the medium as such (T(N,I) or T(N*,I) or the transition temperature T(N*,BP) as such, but instead 2° above the clearing point of the medium in the cell (T_{C}(N,I) or (T_{C}(N*,I)) or or the transition temperature of the medium in the cell (T_{C}(N*,BP)).

The phase width of the blue phase or the total width of a plurality of blue phases is, in the case of the media which have one or more blue phases, determined from the temperature dependence of the electro-optical effect. The temperature at which the electro-optical effect occurs is the temperature at which the optically isotropic phase, the blue phase, occurs (T(N*,BP)). The temperature at which the blue phase or, in the case of media which have more than one blue phase, the last blue phase to occur with increasing temperature disappears and the medium undergoes a transition into the isotropic phase (T(BP,I)) is determined from the temperature dependence of the characteristic voltages, as the temperature at which the typically relatively small increase in the characteristic voltages becomes a greater increase with increasing temperature. The value of T(BP,I) is derived by interpolation of the temperature dependence of the characteristic voltages above and below this temperature, which in many cases is almost linear both above and below this temperature.

In the present application, particularly in the examples described below, the structures of the chemical compounds are indicated by means of abbreviations. The meanings of the respective abbreviations are shown in Tables A and B below. All groups CₙH₂ₙ₊₁ and CₘH₂ₘ₊₁ are straight-chain alkyl groups having n and m C atoms respectively. Table B is self-evident per se since it indicates in each case the complete abbreviation for a formula of homologous compounds. In Table A, only the abbreviations for the core structures of the compound types are shown. The abbreviations for the respective individual compounds are composed of the respectively pertinent abbreviations of these for the core of the compound and the abbreviation for the groups R¹, R², L¹ and L² attached by means of a dash, as shown in the following table.

| Abbreviation | | | | |
|---|---|---|---|---|
| for | | | | |
| R¹, R², L¹, L² | R¹ | R² | L¹ | L² |
| nm | CₙH₂ₙ₊₁ | CₘH₂ₘ₊₁ | H | H |
| nOm | CₙH₂ₙ₊₁ | OCₘH₂ₘ₊₁ | H | H |
| nO.m | OCₙH₂ₙ₊₁ | CₘH₂ₘ₊₁ | H | H |
| n | CₙH₂ₙ₊₁ | CN | H | H |
| nN.F | CₙH₂ₙ₊₁ | CN | H | F |
| nN.F.F | CₙH₂ₙ₊₁ | CN | F | F |
| nON.F.F | OCₙH₂ₙ₊₁ | CN | F | F |
| nOF | OCₙH₂ₙ₊₁ | F | H | H |
| nCl | CₙH₂ₙ₊₁ | Cl | H | H |
| nCl.F | CₙH₂ₙ₊₁ | Cl | H | F |
| nCl.F.F | CₙH₂ₙ₊₁ | Cl | F | F |
| nF | CₙH₂ₙ₊₁ | F | H | H |
| nF.F | CₙH₂ₙ₊₁ | F | H | F |
| nF.F.F | CₙH₂ₙ₊₁ | F | F | F |
| nmF | CₙH₂ₙ₊₁ | CₘH₂ₘ₊₁ | F | H |
| nCF₃ | CₙH₂ₙ₊₁ | CF₃ | H | H |
| nOCF₃ | CₙH₂ₙ₊₁ | OCF₃ | H | H |
| nOCF₃.F | CₙH₂ₙ₊₁ | OCF₃ | H | F |
| nOCF₃.F.F | CₙH₂ₙ₊₁ | OCF₃ | F | F |
| nOCF₂ | CₙH₂ₙ₊₁ | OCHF₂ | H | H |
| nOCF₂.F | CₙH₂ₙ₊₁ | OCHF₂ | H | F |
| nOCF₂.F.F | CₙH₂ₙ₊₁ | OCHF₂ | F | F |
| nS | CₙH₂ₙ₊₁ | NCS | H | H |
| nS.F | CₙH₂ₙ₊₁ | NCS | H | F |
| nS.F.F | CₙH₂ₙ₊₁ | NCS | F | F |
| rVsN | CᵣH₂ᵣ₊₁—CH═CH—CₛH₂ₛ— | CN | H | H |
| rOsN | CᵣH₂ᵣ₊₁—O—CₛH₂ₛ— | CN | H | H |
| nEm | CₙH₂ₙ₊₁ | COOCₘH₂ₘ₊₁ | H | H |

TABLE A

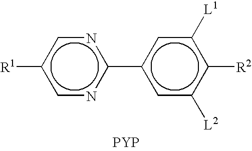

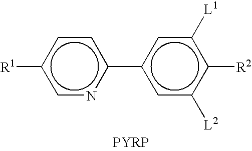

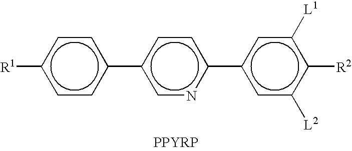

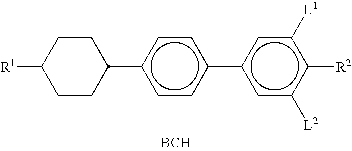

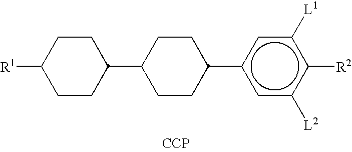

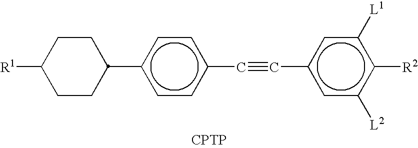

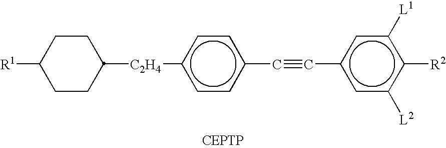

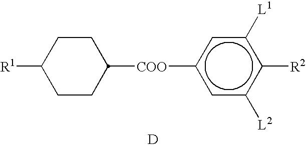

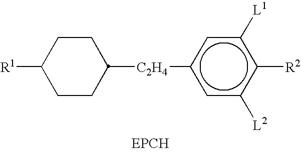

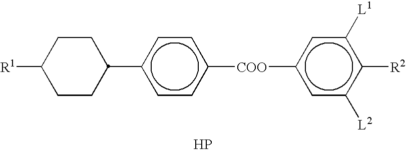

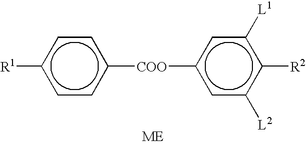

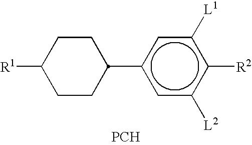

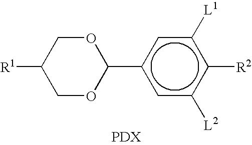

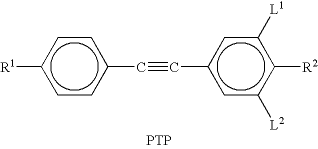

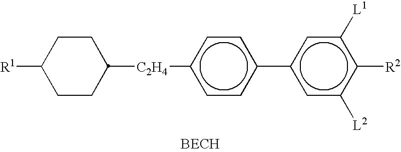

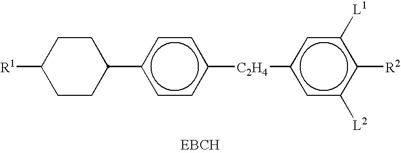

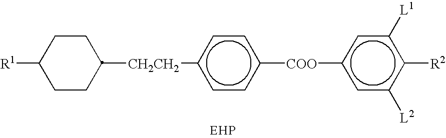

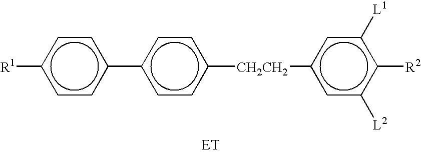

TABLE B

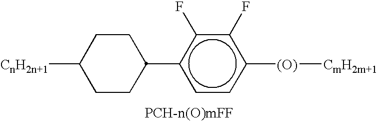

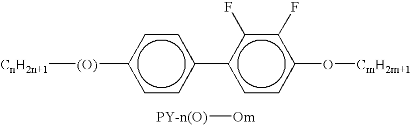

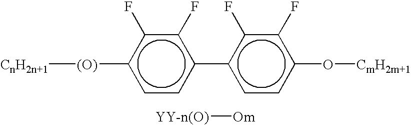

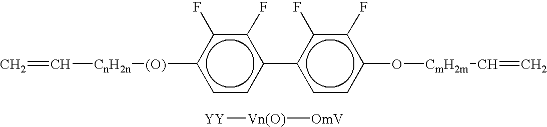

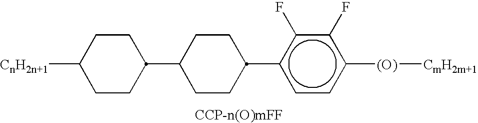

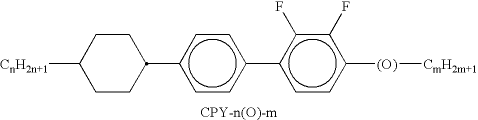

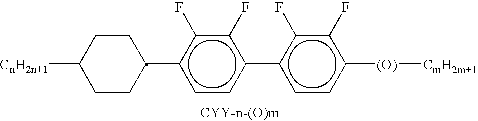

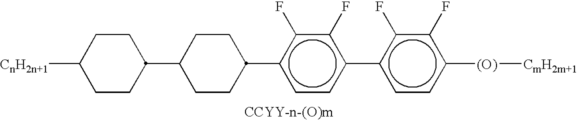

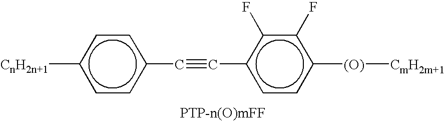

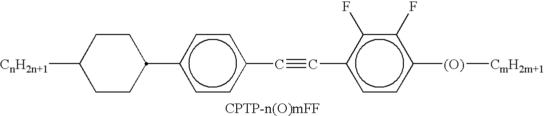

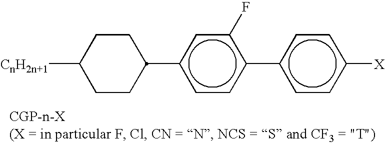

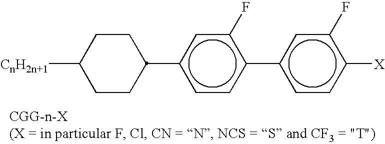

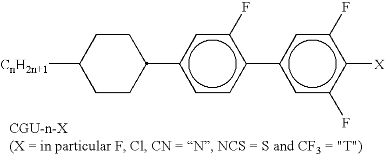

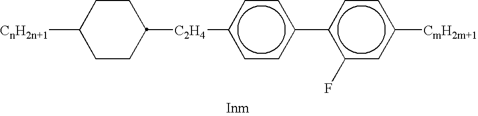

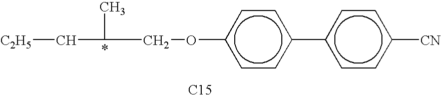

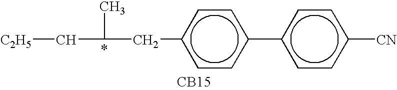

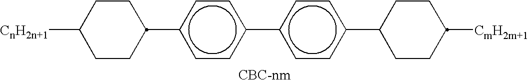

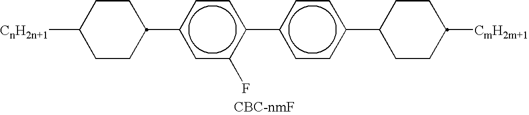

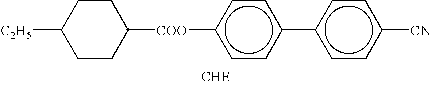

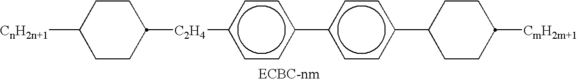

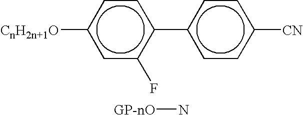

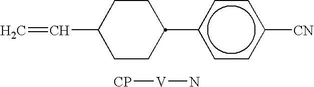

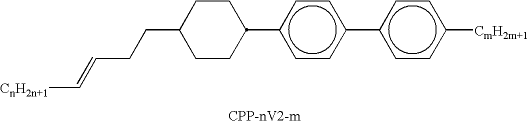

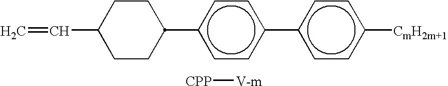

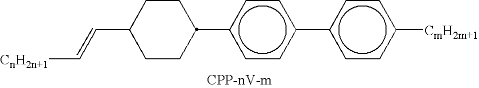

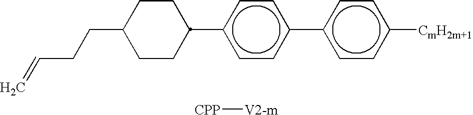

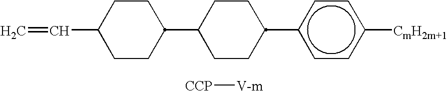

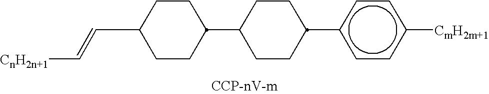

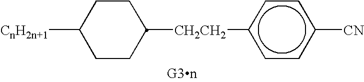

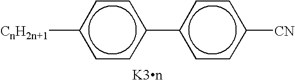

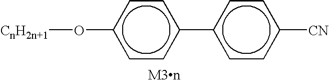

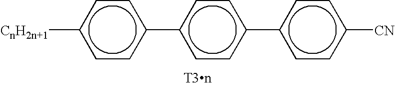

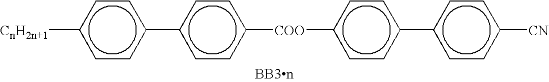

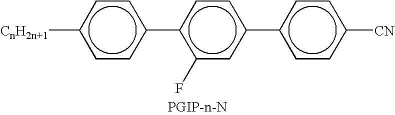

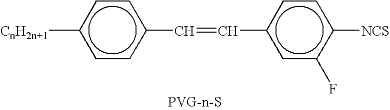

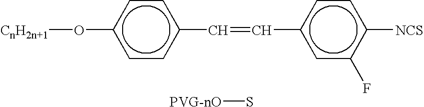

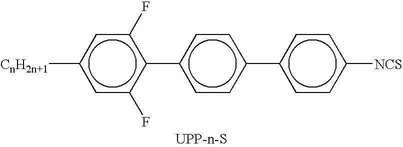

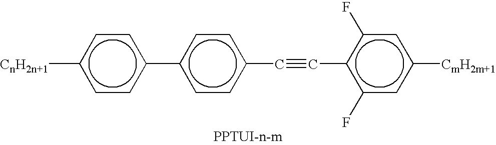

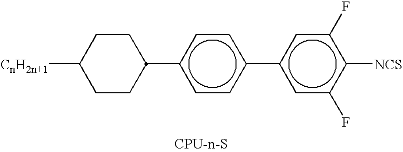

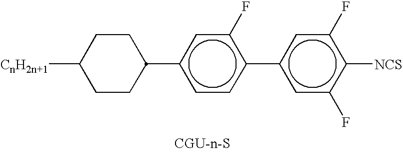

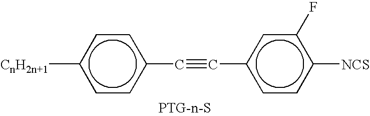

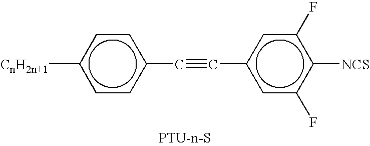

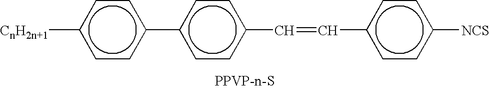

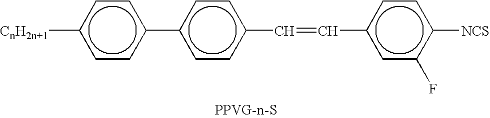

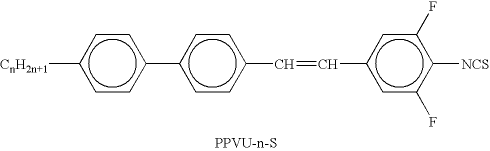

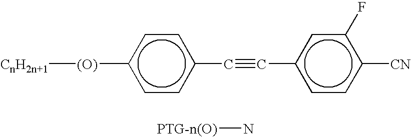

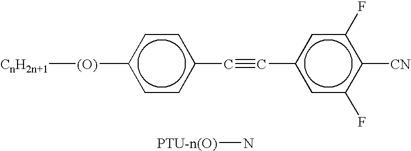

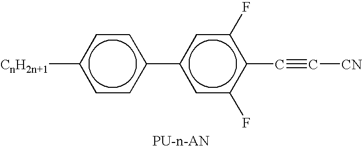

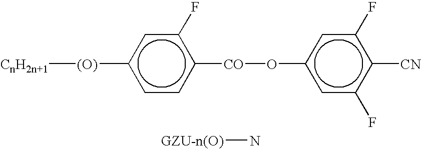

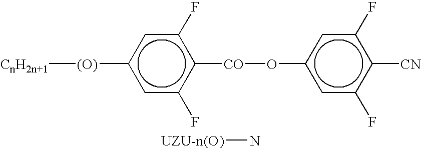

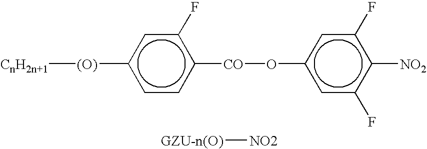

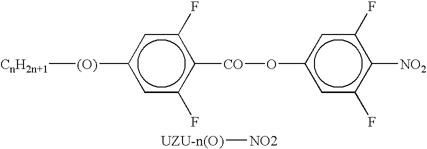

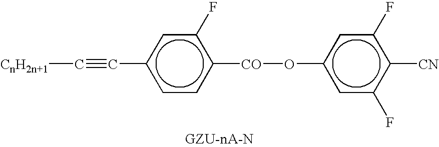

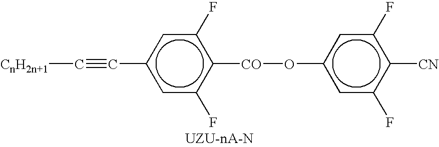

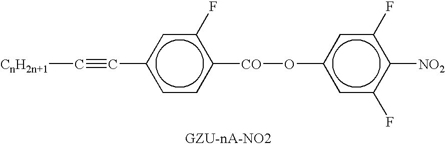

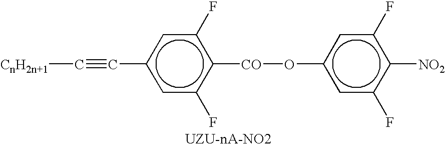

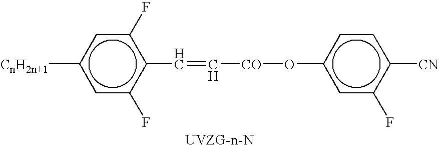

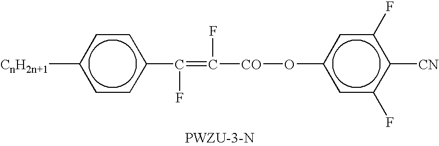

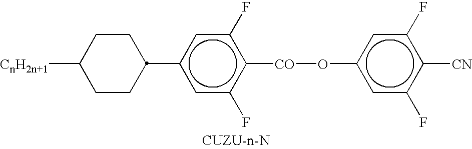

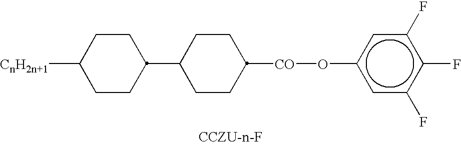

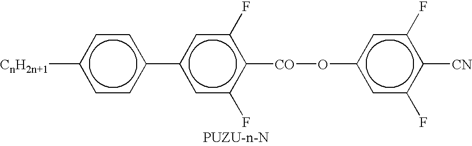

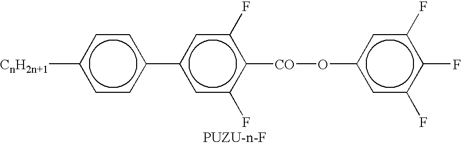

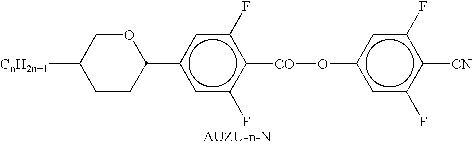

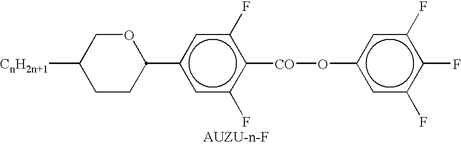

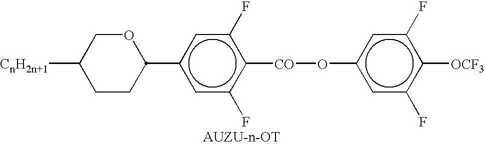

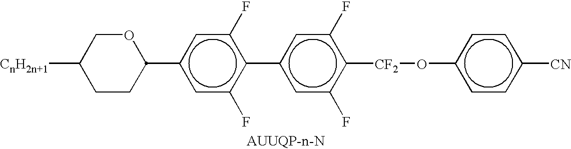

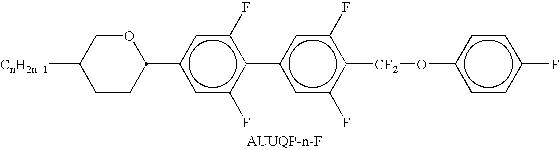

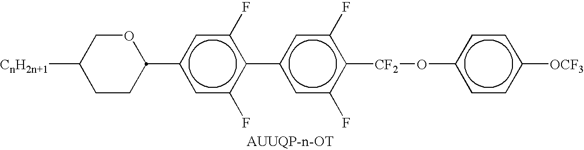

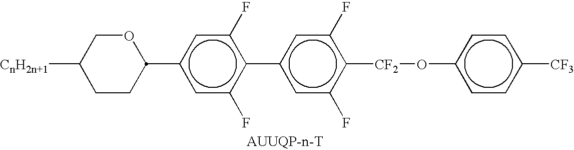

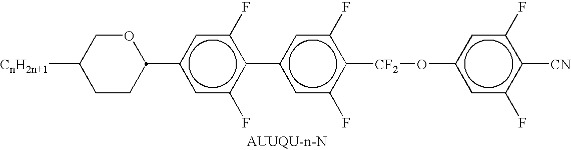

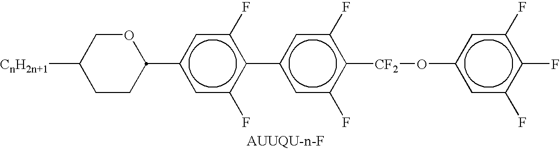

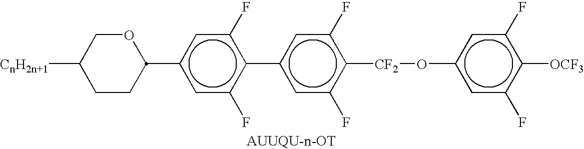

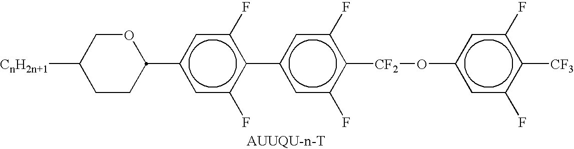

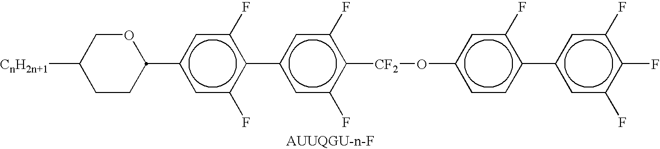

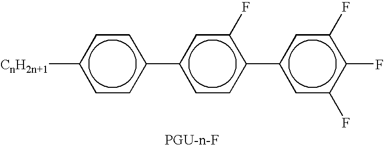

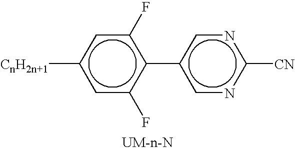

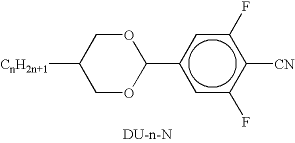

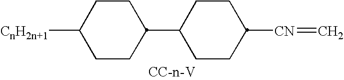

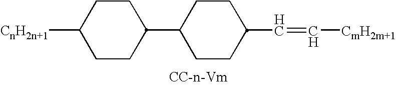

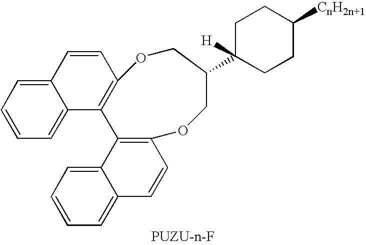

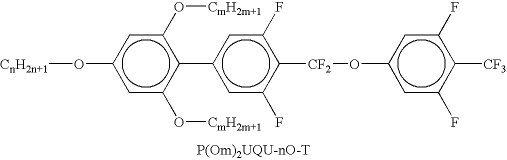

The mesogenic media in accordance with the present application preferably comprise
four or more, preferably six or more, compounds selected from the group consisting of the compounds of Tables A and B and/or
five or more compounds selected from the group consisting of the compounds of Table B and/or
two or more compounds selected from the group consisting of the compounds of Table A.

### EXAMPLES

The examples described below illustrate the present invention without restricting it in any way. They furthermore indicate to the person skilled in the art the properties and in particular the property combinations that can be achieved by means of the present invention.

### Comparative Example 1

The liquid-crystal mixture having the following composition was prepared and investigated.

Composition

| | | Conc./ |
|---|---|---|
| Compound # | Abbreviation | % by wt. |
| 1 | UM-3-N | 10.0 |
| 2 | GZU-3A-N | 10.0 |
| 3 | UVZG-3-N | 10.0 |
| 4 | PWZU-3-N | 7.0 |
| 5 | PU-3-AN | 16.0 |
| 6 | PU-5-AN | 16.0 |
| 7 | PTG-3-N | 15.0 |
| 8 | PTU-4O-N | 15.0 |
| 9 | HP-3N.F | 1.0 |
| Σ | | 100.0 |

Physical properties
T(N, I) = 22.9° C.
nₑ(20° C., 589.3 nm) = 1.7298
Δn(20° C., 589.3 nm) = 0.1765
Δε(20° C., 1 kHz) > 0
ΔH(N, I) = 1.14 J/g
T(N, I) + 4° = 26.9° C.
ε_{av.}(T(N, I) + 4°) = 34.1
T(N, I) + 2° = 24.9° C.
V₇₀(T(N, I) + 2°) = 113 V

This liquid-crystal mixture was introduced into a test cell and its electro-optical properties were investigated at a temperature of 23.1° C., and at 24.9° C. (2° above the clearing point).

The test cell used had interdigital electrodes on only one of the two substrates. An electro-optical test cell with a light switching element containing the liquid-crystal mixture was produced. The substrates consisted of glass. Substrates with no alignment layer and with no passivation layer were used. The electrode structure consisted of comb-shaped electrodes intermeshed with one another. The separation of the electrodes was 15 μm and the width of the electrodes from one another was 10 μm. The layer thickness of the electrodes was about 100 nm. The electrodes were all located in a common plane. The layer thickness of the modulation medium was about 10 μm.

A first polariser was used in front of the cell and a second polariser was used as analyser behind the cell. The absorption axes of the two polarisers formed an angle of 90° to one another. The angle between the axis of maximum absorption of the polarisers and the component of the electric field in the plane of the display was 45° in each case. The voltage/transmission characteristic line was determined using a DMS 703 electro-optical measurement station from Autronic-Melchers, Karlsruhe, Germany. On perpendicular observation, a curve was obtained as is typical of a cell with electrically controlled birefringence (for example ECB).

At 23.1° C., the value of the threshold voltage (V₁₀) is 36.5 V, the value of the mid-grey voltage (V₅₀) is 28 V and the value of the saturation voltage (V₉₀) is 31.5 V. The maximum of the relative contrast is located at 34 V. At 24.9° C., V₇₀ is 113 V. These results are shown in Table 1.

TABLE 1
Characteristic voltages

| Example: | | | | | | |
|---|---|---|---|---|---|---|
| C.1 | C.2 | C.3 | 1 | 2 | 5 | 8 |

Physical parameters

| | | | | | | | |
|---|---|---|---|---|---|---|---|
| ΔH(N, I)/J/g | 1.14 | 1.20 | 0.80 | 0.89 | 0.75 | 0.52 | 0.51 |
| ε_{av.}(T(N, I) + 4°) | 23.1 | 24.0 | 58.5 | 41.5 | 48.0 | 55.0 | 62.2 |

Characteristic line
Electrode separation 10 μm, electrode width 10 μm

| | | | | | | | |
|---|---|---|---|---|---|---|---|
| T/° C. | 23.1 | 24.0 | 24.0 | n.d. | n.d. | n.d. | n.d. |
| V₁₀(T)/V | 36.5 | 22.0 | 40.5 | n.d. | n.d. | n.d. | n.d. |
| V₅₀(T)/V | 28.0 | 35.5 | 56.0 | n.d. | n.d. | n.d. | n.d. |
| V₉₀(T)/V | 31.5 | 44.5 | 65.5 | n.d. | n.d. | n.d. | n.d. |

Electrode separation 15 μm, electrode width 10 μm

| | | | | | | | |
|---|---|---|---|---|---|---|---|
| T(N, I) + 2°/° C. | 24.9 | 25.8 | 25.7 | 34.4 | 37.6 | 7.7 | 16.3 |
| V₇₀(T(N, I) + 2°)/V | 113 | 134 | 71 | 103 | 102 | 67 | 70 |
| dV₇₀/dT/V/° | n.d. | 38 | 18 | n.d. | n.d. | 17 | 17 |
| dV₇₀*/dT/%/° | n.d. | 28 | 25 | n.d. | n.d. | 25 | 24 |

Notes:
n.d.: not determined,
dV₇₀/dT: [V₇₀(T(N, I) + 3°) − V₇₀(T(N, I) + 1°)]/2° and
dV₇₀*/dT: [V₇₀(T(N, I) + 3°) − V₇₀(T(N, I) + 1°)]/[V₇₀(T(N, I) + 2°) · 2°]

As can be seen from this table, the characteristic voltages of the liquid-crystal switching elements of Examples 1, 2, 5 and 8 are significantly lower than those of Comparative Examples 1 and 2. The reduction is already about 10% when comparing Example 1 with Comparative Example 1 and about 25% by comparison with Comparative Example 2.

### Comparative Example 2

The liquid-crystal mixture having the following composition was prepared and investigated. The composition and properties of the mixture are shown in the following table.

Composition

| | | Conc./ |
|---|---|---|
| Compound # | Abbreviation | % by wt. |
| 1 | ME2N.F | 3.0 |
| 2 | ME3N.F | 3.0 |
| 3 | ME4N.F | 8.0 |
| 4 | ME5N.F | 8.0 |
| 5 | UM-3-N | 4.0 |
| 6 | PTG-3-N | 8.0 |
| 7 | PTG-5-N | 8.0 |
| 8 | PTU-4O-N | 8.0 |
| 9 | PU-3-AN | 8.0 |
| 10 | PU-5-AN | 8.0 |
| 11 | PGU-2-F | 10.0 |
| 12 | PGU-3-F | 10.0 |
| 13 | PGU-5-F | 10.0 |
| 14 | HP-3N.F | 4.0 |
| Σ | | 100.0 |

Physical properties
T(N, I) = 23.8° C.
nₑ(20° C., 589.3 nm) = 1.6971
Δn(20° C., 589.3 nm) = 0.1456
ε∥(20° C., 1 kHz) = 47.4
Δε(20° C., 1 kHz) = 27.3
ΔH(N, I) = 1.20 J/g
T(N, I) + 4° = 27.8° C.
ε_{av.}(T(N, I) + 4°) = 24.0
T(N, I) + 2° = 25.8° C.
V₇₀(T(N, I) + 2°) = 134 V
dV/dT(T(N, I) + 2°) = 38 V/°

As in Comparative Example 1, an electro-optical display is produced and its characteristic line measured. At a temperature of 24.0° C., the value of the threshold voltage (V₁₀) is 22 V, the value of the mid-grey voltage (V₅₀) is 35.5 V and the value of the saturation voltage (V₉₀) is 44.5 V.

At a temperature of 2 degrees above the clearing point, V₇₀ is 134 V.

These results are shown in Table 1 for comparison with those of Comparative Example 1.

### Example 1

The liquid-crystal mixture having the following composition was prepared and investigated.

Composition

| | | Conc./ |
|---|---|---|
| Compound # | Abbreviation | % by wt. |
| 1 | CCG-V-F | 15.0 |
| 2 | UZU-3A-N | 10.2 |
| 3 | UZU-5A-N | 10.2 |
| 4 | GZU-3A-N | 10.2 |
| 5 | GZU-4A-N | 9.35 |
| 6 | GZU-4O-N | 8.5 |
| 7 | UVZG-3-N | 8.5 |
| 8 | CUZU-2-N | 8.5 |
| 9 | CUZU-3-N | 8.5 |
| 10 | CUZU-4-N | 8.5 |
| 11 | HP-5N.F | 2.55 |
| Σ | | 100.0 |

Physical properties
T(N, I) = 32.4° C.
Δε(20° C., 1 kHz) > 0
ΔH(N, I) = 0.89 J/g
T(N, I) + 4° = 36.4° C.
ε_{av.}(T(N, I) + 4°) = 41.5
T(N, I) + 2° = 34.4° C.
V₇₀(T(N, I) + 2°) = 103 V

The mixture is introduced into a test cell and investigated as described in Comparative Example 1. In particular, its electro-optical properties are determined at a temperature of 34.4° C.

The cell obtained in this way achieved 70% relative contrast at a voltage of 103 V.

These results are shown in Table 1 for comparison with those of Comparative Examples 1 and 2.

### Example 2

The liquid-crystal mixture having the following composition was prepared and investigated.

Composition

| | | Conc./ |
|---|---|---|
| Compound # | Abbreviation | % by wt. |
| 1 | GZU-4-N | 15.0 |
| 2 | GZU-4O-N | 12.0 |
| 3 | GZU-V2-N | 12.0 |
| 4 | UM-3-N | 9.0 |
| 5 | PYP-4N.F.F | 6.8 |
| 6 | CUZU-2-N | 12.0 |
| 7 | CUZU-3-N | 12.0 |
| 8 | CUZU-4-N | 12.0 |
| 9 | HP-3N.F | 7.0 |
| 10 | HP-5N.F | 2.2 |
| Σ | | 100.0 |

Physical properties
T(N, I) = 35.6° C.
Δε(20° C., 1 kHz) > 0
ΔH(N, I) = 0.75 J/g
T(N, I) + 4° = 39.6° C.
εₐᵥ.(T(N, I) + 4°) = 48.0
T(N, I) + 2° = 37.6° C.
V₇₀(T(N, I) + 2°) = 102 V

The mixture is introduced into a test cell and investigated as described in Comparative Example 1. In particular, its electro-optical properties are determined at a temperature of 37.6 C.

The cell obtained in this way achieved 70% relative contrast at a voltage of 102 V. These results are likewise shown in Table 1 for comparison with those of Comparative Examples 1 and 2.

### Examples 3 to 10 and Comparative Examples 3 to 22

The liquid-crystal mixtures having the following compositions are prepared and investigated.

### Example 3

Composition

| | | Conc./ |
|---|---|---|
| Compound # | Abbreviation | % by wt. |
| 1 | UZU-3A-N | 16.0 |
| 2 | UZU-5A-N | 18.0 |
| 3 | GZU-4O-N | 15.0 |
| 4 | CUZU-2-N | 18.0 |
| 5 | CUZU-3-N | 15.0 |
| 6 | CUZU-4-N | 18.0 |
| Σ | | 100.0 |

Physical properties
T(N, I) = 37.4° C.
Δε(20° C., 1 kHz) > 0
ΔH(N, I) = 0.75 J/g
T(N, I) + 4° = 52.7° C.
εₐᵥ.(T(N, I) + 4°) = 41.5
T(N, I) + 2° = 39.4° C.
V₇₀(T(N, I) + 2°) = 88 V

### Example 4

Composition

| | | Conc./ |
|---|---|---|
| Compound # | Abbreviation | % by wt. |
| 1 | UVZG-3-N | 15.0 |
| 2 | GZU-4-N | 4.0 |
| 3 | GZU-4O-N | 15.0 |
| 4 | UM-3-N | 10.0 |
| 5 | DU-2-N | 15.0 |
| 6 | CUZU-2-N | 15.0 |
| 7 | CUZU-3-N | 15.0 |
| 8 | CUZU-4-N | 11.0 |
| Σ | | 100.0 |

Physical properties
T(N, I) = 22.0° C.
Δε(20° C., 1 kHz) > 0
ΔH(N, I) = 0.92 J/g
T(N, I) + 4° = 26.0° C.
εₐᵥ.(T(N, I) + 4°) = 55.8
T(N, I) + 2° = 24.0° C.
V₇₀(T(N, I) + 2°) = 101 V

### Comparative Example 3

Composition

| | | Conc./ |
|---|---|---|
| Compound # | Abbreviation | % by wt. |
| 1 | UZU-3A-N | 12.0 |
| 2 | UZU-5A-N | 12.0 |
| 3 | GZU-3A-N | 12.0 |
| 4 | GZU-4A-N | 11.0 |
| 5 | GZU-4O-N | 10.0 |
| 6 | UVZG-3-N | 10.0 |
| 7 | CUZU-2-N | 10.0 |
| 8 | CUZU-3-N | 10.0 |
| 9 | CUZU-4-N | 10.0 |
| 10 | HP-5N.F | 3.0 |
| Σ | | 100.0 |

Physical properties
T(N, I) = 23.7° C.
nₑ(20° C., 589.3 nm) = 1.6187
Δn(20° C., 589.3 nm) = 0.0925
Δε(20° C., 1 kHz) > 0
ΔH(N, I) = 0.80 J/g
T(N, I) + 4° = 27.7° C.
εₐᵥ.(T(N, I) + 4°) = 58.5
T(N, I) + 2° = 25.7° C.
V₇₀(T(N, I) + 2°) = 71 V
dV/dT(T(N, I) + 2°) = 18 V/°

As in Example 1, the electro-optical properties of the mixture were investigated in a test cell at a temperature of 2 above the clearing point, in particular V₇₀ was determined as 71 V.

In addition, the electro-optical properties of the mixture were investigated in a test cell at a temperature of 24.0° C. The value of the threshold voltage (V₁₀) was 40.5 V, the value of the mid-grey voltage (V₅₀) was 56 V and the value of the saturation voltage (V₉₀) was 65 V. The maximum contrast was reached at 73 V. At voltages of 80 V and 90 V, the relative contrast dropped back to 90% and 50% respectively.

These results are likewise shown in Table 1 for comparison with those of Comparative Examples 1 and 2 and Examples 1 and 2.

### Comparative Example 4

Composition

| | | Conc./ |
|---|---|---|
| Compound # | Abbreviation | % by wt. |
| 1 | UM-3-N | 10.0 |
| 2 | PYP-3N.F.F | 15.0 |
| 3 | UZU-3A-N | 12.0 |
| 4 | GZU-3A-N | 12.0 |
| 5 | GZU-4-N | 1.0 |
| 6 | GZU-4O-N | 10.0 |
| 7 | UVZG-3-N | 10.0 |
| 8 | CUZU-2-N | 10.0 |
| 9 | CUZU-3-N | 10.0 |
| 10 | HP-3N.F | 10.0 |
| Σ | | 100.0 |

Physical properties
T(N, I) = 24.8° C.
Δε(20° C., 1 kHz) > 0
ΔH(N, I) = 0.82 J/g
T(N, I) + 4° = 28.8° C.
εₐᵥ.(T(N, I) + 4°) = 60.5
T(N, I) + 2° = 26.8° C.
V₇₀(T(N, I) + 2°) = 79 V

### Example 5

Composition

| | | Conc./ |
|---|---|---|
| Compound # | Abbreviation | % by wt. |
| 1 | UZU-3A-N | 7.5 |
| 2 | GZU-3A-N | 15.0 |
| 3 | GZU-4A-N | 15.0 |
| 4 | GZU-4O-N | 15.0 |
| 5 | PU-3-AN | 10.0 |
| 6 | PTU-4O-N | 15.0 |
| 6 | CUZU-2-N | 15.0 |
| 7 | CUZU-3-N | 7.5 |
| Σ | | 100.0 |

Physical properties
T(N, I) = 5.7° C.
Δε(20° C., 1 kHz) > 0
ΔH(N, I) = 0.52 J/g
T(N, I) + 4° = 9.7° C.
ε_{av.}(T(N, I) + 4°) = 55.0
T(N, I) + 2° = 7.7° C.
V₇₀(T(N, I) + 2°) = 67 V
dV/dT(T(N, I) + 2°) = 17 V/°

### Example 6

Composition

| | | Conc./ |
|---|---|---|
| Compound # | Abbreviation | % by wt. |
| 1 | UZU-3A-N | 12.0 |
| 2 | UZU-5A-N | 4.5 |
| 3 | GZU-3A-N | 12.0 |
| 4 | GZU-4A-N | 12.0 |
| 5 | GZU-4-N | 10.0 |
| 6 | GZU-4O-N | 11.0 |
| 7 | CUZU-2-N | 11.0 |
| 8 | CUZU-3-N | 11.0 |
| 9 | CUZU-4-N | 11.0 |
| 10 | HP-3N.F | 5.5 |
| Σ | | 100.0 |

Physical properties
T(N, I) = 24.0° C.
Δε(20° C., 1 kHz) > 0
ΔH(N, I) = 0.55 J/g
T(N, I) + 4° = 28.0° C.
ε_{av.}(T(N, I) + 4°) = 60.2
T(N, I) + 2° = 26.0° C.
V₇₀(T(N, I) + 2°) = 75 V

### Example 7

Composition

| | | Conc./ |
|---|---|---|
| Compound # | Abbreviation | % by wt. |
| 1 | UZU-3A-N | 15.0 |
| 2 | UZU-5A-N | 5.6 |
| 3 | GZU-3A-N | 15.0 |
| 4 | GZU-4A-N | 15.0 |
| 5 | GZU-4O-N | 12.0 |
| 6 | CUZU-2-N | 11.0 |
| 7 | CUZU-3-N | 11.0 |
| 8 | CUZU-4-N | 11.0 |
| 9 | HP-3N.F | 4.4 |
| Σ | | 100.0 |

Physical properties
T(N, I) = 22.5° C.
Δε(20° C., 1 kHz) > 0
ΔH(N, I) = 0.57 J/g
T(N, I) + 4° = 26.5° C.
ε_{av.}(T(N, I) + 4°) = 60.8
T(N, I) + 2° = 24.5° C.
V₇₀(T(N, I) + 2°) = 69 V

### Example 8

Composition

| | | Conc./ |
|---|---|---|
| Compound # | Abbreviation | % by wt. |
| 1 | UZU-5A-NO2 | 10.0 |
| 2 | UZU-3A-N | 10.8 |
| 3 | UZU-5A-N | 10.8 |
| 4 | GZU-3A-N | 10.8 |
| 5 | GZU-4A-N | 9.9 |
| 6 | GZU-4O-N | 9.0 |
| 7 | UVZG-3-N | 9.0 |
| 8 | CUZU-2-N | 9.0 |
| 9 | CUZU-3-N | 9.0 |
| 10 | CUZU-4-N | 9.0 |
| 11 | HP-5N.F | 2.7 |
| Σ | | 100.0 |

Physical properties
T(N, I) = 14.3° C.
Δε(20° C., 1 kHz) > 0
ΔH(N, I) = 0.51 J/g
T(N, I) + 4° = 18.3° C.
ε_{av.}(T(N, I) + 4°) = 62.2
T(N, I) + 2° = 16.3° C.
V₇₀(T(N, I) + 2°) = 70 V
dV/dT(T(N, I) + 2°) = 17 V/°

These results are likewise shown in Table 1 for comparison with those of Comparative Examples 1 to 3 and Examples 1 and 2.

### Comparative Example 5

Composition

| | | Conc./ |
|---|---|---|
| Compound # | Abbreviation | % by wt. |
| 1 | CGU-2-F | 11.0 |
| 2 | CGU-3-F | 11.0 |
| 3 | CGU-5-F | 10.0 |
| 4 | BCH-3F.F.F | 18.0 |
| 5 | BCH-5F.F.F | 14.0 |
| 6 | PGU-2-F | 11.0 |
| 7 | PGU-3-F | 11.0 |
| 8 | BCH-32 | 3.0 |
| Σ | | 100.0 |

Physical properties
T(N, I) = 23.5° C.
nₑ(20° C., 589.3 nm) = 1.6138
Δn(20° C., 589.3 nm) = 0.0854
ε∥(20° C., 1 kHz) = 16.5
Δε(20° C., 1 kHz) = 9.1
T(N, I) + 4° = 27.5° C.
ε_{av.}(T(N, I) + 4°) < 12.9
T(N, I) + 2° = 25.5° C.
V₇₀(T(N, I) + 2°) = 63 V

### Comparative Example 6

Composition

| | | Conc./ |
|---|---|---|
| Compound # | Abbreviation | % by wt. |
| 1 | ME2N.F | 10.0 |
| 2 | UM-3-N | 8.5 |
| 3 | PTG-3-N | 15.0 |
| 4 | PTG-5-N | 15.0 |
| 5 | PU-3-AN | 15.0 |
| 6 | PU-5-AN | 15.0 |
| 7 | PTU-4O-N | 15.0 |
| 8 | HP-3N.F | 6.5 |
| Σ | | 100.0 |

Physical properties
T(N, I) = 29.6° C.
nₑ(20° C., 589.3 nm) = 1.7549
Δn(20° C., 589.3 nm) = 0.2092
ε∥(20° C., 1 kHz) = 59.2
Δε(20° C., 1 kHz) = 42.9
ΔH(N, I) = 0.95 J/g
T(N, I) + 4° = 33.6° C.
ε_{av.}(T(N, I) + 4°) = 26.4

### Comparative Example 7

Composition

| | | Conc./ |
|---|---|---|
| Compound # | Abbreviation | % by wt. |
| 1 | UM-3-N | 8.0 |
| 2 | GZU-3A-N | 8.0 |
| 3 | UVZG-3-N | 8.0 |
| 4 | PWZU-3-N | 10.0 |
| 5 | PYP-40N.F.F | 6.0 |
| 6 | PU-3-AN | 15.0 |
| 7 | PU-5-AN | 15.0 |
| 8 | PTG-3-N | 15.0 |
| 9 | PTU-4O-N | 15.0 |
| Σ | | 100.0 |

Physical properties
T(N, I) = 21.0° C.
Δε(20° C., 1 kHz) > 0
ΔH(N, I) = 0.81 J/g
T(N, I) + 4° = 25.0° C.
ε_{av.}(T(N, I) + 4°) = 34.8

### Comparative Example 8

Composition

| | | Conc./ |
|---|---|---|
| Compound # | Abbreviation | % by wt. |
| 1 | PTG-3-N | 15.0 |
| 2 | PTP-5-N | 15.0 |
| 3 | PTU-4O-N | 15.0 |
| 4 | PU-5-AN | 9.0 |
| 5 | PGU-5-F | 14.0 |
| 6 | HP-3N.F | 7.0 |
| 7 | HP-3N.F | 8.0 |
| 8 | DU-2-N | 15.0 |
| 9 | PCH-3N.F.F | 2.0 |
| Σ | | 100.0 |

Physical properties
T(N, I) = 24.2° C.
nₑ(20° C., 589.3 nm) = 1.6857
Δn(20° C., 589.3 nm) = 0.1405
ε∥(20° C., 1 kHz) = 45.8
Δε(20° C., 1 kHz) = 27.8
ΔH(N, I) = 0.62 J/g
T(N, I) + 4° = 28.2° C.
ε_{av.}(T(N, I) + 4°) = 24.7

### Comparative Example 9

Composition

| | | Conc./ |
|---|---|---|
| Compound # | Abbreviation | % by wt. |
| 1 | CCP-2F.F.F | 10.0 |
| 2 | CCP-3F.F.F | 10.0 |
| 3 | CCP-5F.F.F | 10.0 |
| 4 | ME2N.F | 10.0 |
| 5 | ME3N.F | 10.0 |
| 6 | ME4N.F | 7.0 |
| 7 | ME5N.F | 15.0 |
| 8 | DU-2-N | 6.0 |
| 9 | PCH-5N.F.F | 2.0 |
| 10 | UM-3-N | 10.0 |
| 11 | HP-3N.F | 10.0 |
| Σ | | 100.0 |

Physical properties
T(N, I) = 30.1° C.
nₑ(20° C., 589.3 nm) = 1.6095
Δn(20° C., 589.3 nm) = 0.1035
ε∥(20° C., 1 kHz) = 62.6
Δε(20° C., 1 kHz) = 45.9
ΔH(N, I) = 0.92 J/g
T(N, I) + 4° = 34.1° C.
ε_{av.}(T(N, I) + 4°) = 26.7

### Comparative Example 10

Composition

| | | Conc./ |
|---|---|---|
| Compound # | Abbreviation | % by wt. |
| 1 | UM-3-N | 6.0 |
| 2 | GZU-3A-N | 10.0 |
| 3 | UVZG-3-N | 12.0 |
| 4 | PWZU-3-N | 10.0 |
| 5 | PU-3-AN | 15.0 |
| 6 | PU-5-AN | 15.0 |
| 7 | PTG-3-N | 15.0 |
| 8 | PTU-4O-N | 15.0 |
| 9 | HP-3N.F | 2.0 |
| Σ | | 100.0 |

Physical properties
T(N, I) = 29.0° C.
Δε(20° C., 1 kHz) = >0
ΔH(N, I) = 0.79 J/g
T(N, I) + 4° = 33.0° C.
ε_{av.}(T(N, I) + 4°) = 35.2

### Comparative Example 11

Composition

| | | Conc./ |
|---|---|---|
| Compound # | Abbreviation | % by wt. |
| 1 | CGU-2-F | 11.0 |
| 2 | CGU-3-F | 11.0 |
| 3 | CGU-5-F | 10.0 |
| 4 | BCH-3F.F.F | 16.0 |
| 5 | BCH-5F.F.F | 14.0 |
| 6 | PGU-2-F | 10.0 |
| 7 | PGU-3-F | 10.0 |
| 8 | PGU-5-F | 9.0 |
| 9 | PCH-7F | 9.0 |
| Σ | | 100.0 |

Physical properties
T(N, I) = 11.5° C.
Δε(20° C., 1 kHz) = >0
T(N, I) + 4° = 15.5° C.
ε_{av.}(T(N, I) + 4°) < 11

### Comparative Example 12

Composition

| | | Conc./ |
|---|---|---|
| Compound # | Abbreviation | % by wt. |
| 1 | CGU-2-F | 12.0 |
| 2 | CGU-3-F | 12.0 |
| 3 | CGU-5-F | 11.0 |
| 4 | BCH-3F.F.F | 18.0 |
| 5 | BCH-5F.F.F | 14.0 |
| 6 | PGU-2-F | 11.0 |
| 7 | PGU-3-F | 10.0 |
| 8 | PGU-5-F | 11.0 |
| Σ | | 100.0 |

Physical properties
T(N, I) = 15.5° C.
Δε(20° C., 1 kHz) > 0
T(N, I) + 4° = 19.5° C.
ε_{av.}(T(N, I) + 4°) < 11

### Comparative Example 13

Composition

| | | Conc./ |
|---|---|---|
| Compound # | Abbreviation | % by wt. |
| 1 | ME2N.F | 3.0 |
| 2 | ME3N.F | 3.0 |
| 3 | ME4N.F | 5.0 |
| 4 | ME5N.F | 3.0 |
| 5 | UM-3-N | 4.0 |
| 6 | PTG-3-N | 8.0 |
| 7 | PTG-5-N | 8.0 |
| 8 | PTU-4O-N | 7.0 |
| 9 | PU-3-AN | 8.0 |
| 10 | PU-5-AN | 8.0 |
| 11 | PGU-2-F | 10.0 |
| 12 | PGU-3-F | 10.0 |
| 13 | PGU-5-F | 10.0 |
| 14 | HP-3N.F | 5.0 |
| 15 | HP-4N.F | 5.0 |
| 16 | HP-5N.F | 4.0 |
| Σ | | 100.0 |

Physical properties
T(N, I) = 42.3° C.
Δε(20° C., 1 kHz) > 0
ΔH(N, I) = 0.80 J/g
T(N, I) + 4° = 46.3° C.
ε_{av.}(T(N, I) + 4°) = 21.2

### Comparative Example 14

Composition

| | | Conc./ |
|---|---|---|
| Compound # | Abbreviation | % by wt. |
| 1 | ME2N.F | 3.0 |
| 2 | ME3N.F | 3.0 |
| 3 | ME4N.F | 8.0 |
| 4 | ME5N.F | 9.0 |
| 5 | UM-3-N | 4.0 |
| 6 | PTG-3-N | 9.0 |
| 7 | PTG-5-N | 8.0 |
| 8 | PTU-4O-N | 8.0 |
| 9 | PU-3-AN | 9.0 |
| 10 | PU-5-AN | 9.0 |
| 11 | PGU-2-F | 10.0 |
| 12 | PGU-3-F | 10.0 |
| 13 | PGU-5-F | 10.0 |
| Σ | | 100.0 |

Physical properties
T(N, I) = 16.0° C.
Δε(20° C., 1 kHz) > 0
ΔH(N, I) = 0.82 J/g
T(N, I) + 4° = 20.0° C.
ε_{av.}(T(N, I) + 4°) = 24.7

### Comparative Example 15

Composition

| | | Conc./ |
|---|---|---|
| Compound # | Abbreviation | % by wt. |
| 1 | YY-2-O2 | 8.0 |
| 2 | YY-3-O2 | 8.0 |
| 3 | YY-4O-O4 | 10.0 |
| 4 | YY-V1O-O1V | 8.0 |
| 5 | PY-3-O2 | 15.0 |
| 6 | PY-1-O2 | 11.0 |
| 7 | CYY-3-O2 | 10.0 |
| 8 | CYY-5-O2 | 10.0 |
| 9 | PTP-302FF | 10.0 |
| 10 | PTP-502FF | 10.0 |
| Σ | | 100.0 |

Physical properties
T(N, I) = 16.0° C.
Δε(20° C., 1 kHz) < 0
T(N, I) + 4° = 20.0° C.
ε_{av.}(T(N, I) + 4°) < 3.0

### Comparative Example 16

Composition

| | | Conc./ |
|---|---|---|
| Compound # | Abbreviation | % by wt. |
| 1 | YY-2-O2 | 8.0 |
| 2 | YY-3-O2 | 8.0 |
| 3 | YY-3O-O4 | 6.0 |
| 4 | YY-4O-O4 | 6.0 |
| 5 | YY-V1O-O1V | 6.0 |
| 6 | PY-3-O2 | 9.0 |
| 7 | PY-1-O2 | 12.0 |
| 8 | CYY-3-O2 | 9.0 |
| 9 | CYY-5-O2 | 9.0 |
| 10 | PTP-302FF | 10.0 |
| 11 | PTP-302FF | 10.0 |
| 12 | CPY-3-O2 | 5.0 |
| 13 | CCYY-2-O2 | 2.0 |
| Σ | | 100.0 |

Physical properties
T(N, I) = 16.0° C.
Δε(20° C., 1 kHz) < 0
T(N, I) + 4° = 20.0° C.
ε_{av.}(T(N, I) + 4°) < 3.5

### Comparative Example 17

Composition

| | | Conc./ |
|---|---|---|
| Compound # | Abbreviation | % by wt. |
| 1 | PYP-5F | 25.0 |
| 2 | PCH-32 | 16.5 |
| 3 | PCH-301 | 15.0 |
| 4 | PCH-302 | 11.3 |
| 5 | BCH-32 | 14.3 |
| 6 | BCH-52 | 10.5 |
| 7 | CBC-33 | 3.7 |
| 8 | CBC-53 | 3.7 |
| Σ | | 100.0 |

Physical properties
T(N, I) = 41.0° C.
nₑ(20° C., 589.3 nm) = 1.6157
Δn(20° C., 589.3 nm) = 0.1066
ε∥(20° C., 1 kHz) = 5.7
Δε(20° C., 1 kHz) = 2.4
T(N, I) + 4° = 45.0° C.
ε_{av.}(T(N, I) + 4°) < 4.1

### Comparative Example 18

Composition

| | | Conc./ |
|---|---|---|
| Compound # | Abbreviation | % by wt. |
| 1 | PCH-5F | 14.6 |
| 2 | PCH-6F | 12.9 |
| 3 | PCH-7F | 12.5 |
| 4 | PTP-20F | 15.2 |
| 5 | PTP-40F | 19.1 |
| 6 | PTP-60F | 25.7 |
| Σ | | 100.0 |

Physical properties
T(N, I) = 27.0° C.
nₑ(20° C., 589.3 nm) = 1.6470
Δn(20° C., 589.3 nm) = 0.1350
ε∥(20° C., 1 kHz) = 7.4
Δε(20° C., 1 kHz) = 3.6
T(N, I) + 4° = 31.0° C.
ε_{av.}(T(N, I) + 4°) < 5.6

### Comparative Example 19

Composition

| | | Conc./ |
|---|---|---|
| Compound # | Abbreviation | % by wt. |
| 1 | CCP-2F.F.F | 4.0 |
| 2 | CCP-20CF3 | 4.0 |
| 3 | CCP-30CF3 | 5.0 |
| 4 | CCP-40CF3 | 2.0 |
| 5 | PCH-3 | 6.0 |
| 6 | K9 | 4.0 |
| 7 | BCH-3F.F.F | 12.0 |
| 8 | CGU-2-F | 10.0 |
| 9 | CGU-3-F | 6.0 |
| 10 | CCZU-2-F | 5.0 |
| 11 | CCZU-3-F | 16.0 |
| 12 | CCZU-5-F | 5.0 |
| 13 | CC-5-V | 2.0 |
| 14 | CCP-V-1 | 10.0 |
| 15 | CC-3-V1 | 9.0 |
| Σ | | 100.0 |

Physical properties
T(N, I) = 30.0° C.
nₑ(20° C., 589.3 nm) = 1.5856
Δn(20° C., 589.3 nm) = 0.1007
ε∥(20° C., 1 kHz) = 14.5
Δε(20° C., 1 kHz) = 10.6
T(N, I) + 4° = 34.0° C.
ε_{av.}(T(N, I) + 4°) < 4.7

### Comparative Example 20

Composition

| | | Conc./ |
|---|---|---|
| Compound # | Abbreviation | % by wt. |
| 1 | PCH-5 | 19.0 |
| 2 | PCH-302 | 31.0 |
| 3 | PCH-304 | 31.0 |
| 4 | K15 | 19.0 |
| Σ | | 100.0 |

Physical properties
T(N, I) = 33.0° C.
nₑ(20° C., 589.3 nm) = 1.6010
Δn(20° C., 589.3 nm) = 0.1100
ε∥(20° C., 1 kHz) = 9.5
Δε(20° C., 1 kHz) = 4.9
T(N, I) + 4° = 37.0° C.
ε_{av.}(T(N, I) + 4°) < 6.2

### Comparative Example 21

Composition

| | | Conc./ |
|---|---|---|
| Compound # | Abbreviation | % by wt. |
| 1 | PCH-302FF | 26.0 |
| 2 | PCH-502FF | 26.0 |
| 3 | CCP-V-1 | 15.0 |
| 4 | CC-5-V | 19.0 |
| 5 | CCH-35 | 8.0 |
| 6 | BCH-32 | 6.0 |
| Σ | | 100.0 |

Physical properties

T(N, I) = 50.0° C.
Δε(20° C., 1 kHz) < 0
T(N, I) + 4° = 54.0° C.
εₐᵥ.(T(N, I) + 4°) < 2.0

### Comparative Example 22

Composition

| | | Conc./ |
|---|---|---|
| Compound # | Abbreviation | % by wt. |
| 1 | PCH-302FF | 26.0 |
| 2 | PCH-502FF | 26.0 |
| 3 | CCP-V-1 | 13.0 |
| 4 | CC-5-V | 16.0 |
| 5 | CCH-35 | 5.0 |
| 6 | BCH-32 | 9.0 |
| 7 | CCP-21FF | 3.0 |
| 8 | PCH-301 | 2.0 |
| Σ | | 100.0 |

Physical properties

T(N, I) = 50.0° C.
nₑ(20° C., 589.3 nm) = 1.5640
Δn(20° C., 589.3 nm) = 0.0821
ε||(20° C., 1 kHz) = 3.9
Δε(20° C., 1 kHz) = −2.9
T(N, I) + 4° = 54.0° C.
εₐᵥ.(T(N, I) + 4°) < 2.0

### Example 9

Composition

| | | Conc./ |
|---|---|---|
| Compound # | Abbreviation | % by wt. |
| 1 | AUUQU-3-N | 10.0 |
| 2 | CUZU-3-N | 9.0 |
| 3 | CUZU-4-N | 9.0 |
| 4 | HP-3N.F | 8.0 |
| 5 | AUUQU-3-OT | 10.0 |
| 6 | AUUQU-3-F | 9.0 |
| 7 | AUUQU-3-T | 8.0 |
| 8 | AUUQP-3-T | 5.0 |
| 9 | PUZU-3-F | 9.0 |
| 10 | PUZU-5-F | 8.0 |
| 11 | P(O3)₂UQU-30-T | 10.0 |
| 12 | N(O1)₂C*H-C-3 | 5.0 |
| Σ | | 100.0 |

Physical properties

T(BP, I) = 43.5° C.
T(N*, BP) = 30.0° C.
ΔT(BP) = 13.5°
Δε(20° C., 1 kHz) > 0
T(N*, BP) + 4° = 34.0° C.
εₐᵥ.(T(N*, I) + 4°) = 42
T(N*, I) + 2° = 32.0° C.
V₉₀(T(N*, I) + 2°) = 40 V

The modulation medium of this example has a transition from the nematic (here highly twisted cholesteric) phase into the blue phase. It has a low characteristic voltage V₉₀ and is characterised by particularly favourable, low temperature dependence of the characteristic voltages, also in comparison with Examples 1 to 8 of the present application.

### Example 10

Composition

| | | Conc./ |
|---|---|---|
| Compound # | Abbreviation | % by wt. |
| 1 | AUUQU-3-N | 9.98 |
| 2 | AUZU-3-N | 9.98 |
| 3 | AUZU-4-N | 9.98 |
| 4 | GZU-3A-N | 8.00 |
| 5 | HP-3N.F | 6.02 |
| 6 | AUUQU-3-OT | 9.98 |
| 7 | AUUQU-3-T | 8.00 |
| 8 | AUUQU-3-F | 9.03 |
| 9 | AUUQGU-3-F | 8.00 |
| 10 | PUZU-3-F | 7.05 |
| 11 | P(O3)₂UQU-30-T | 5.0 |
| 12 | N(O1)₂C*H-C-3 | 9.0 |
| Σ | | 100.0 |

Physical properties

T(BP, I) = 44.5° C.
T(N*, BP) = 23.5° C.
ΔT(BP) = 21.0°
Δε(20° C., 1 kHz) > 0
T(N*, BP) + 4° = 27.5° C.
εₐᵥ.(T(N*, I) + 4°) = 43
T(N*, I) + 2° = 25.5° C.
V₉₀(T(N*, I) + 2°) = 76 V

The modulation medium of this example has, like that of Example 9, a transition from the highly twisted cholesteric phase into the blue phase. It is characterised by very particularly favourable, low temperature dependence of the characteristic voltages.

### DESCRIPTION OF THE FIGURES

FIG. 1: The figure shows diagrammatically a cross section of the construction of a switching element or part of a switching element in accordance with the present application. The modulation medium (2) is located between the inner surfaces of the substrates (1) and (1′). The two electrodes (3) and (4) of the electrode structure, to which different potentials can be applied, are located on the inner surface of one substrate (1). Vop denotes the source of the voltage, charge or current. The lines emanating from Vop symbolise the electric supply lines to the electrodes.

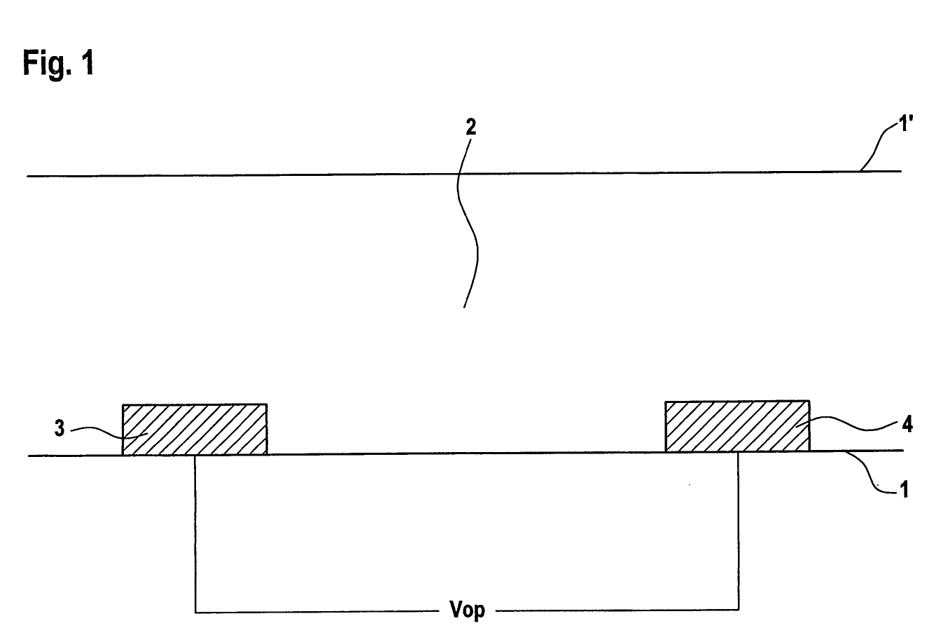

LIST OF THE MEANINGS OF THE REFERENCE SYMBOLS IN THE FIGURES
1: Surface of the first substrate,
1′: Surface of the 2nd substrate,
2: Modulation layer,
3: Conductive layer of the electrode structure to which the 1st potential can be applied,
4: Conductive layer of the electrode structure to which the 2nd potential can be applied,
Vop: Source of the voltage, charge or current.

1. Electro-optical light modulation element comprising
a substrate or a plurality of substrates,
an electrode arrangement,
at least one element or a plurality of elements for polarisation of the light and
a modulation medium,
characterised in that
the light modulation element is operated at a temperature at which the modulation medium is in an optically isotropic phase in the unaddressed state, and in that
the electrode arrangement can generate an electric field having a significant component parallel to the surface of the mesogenic modulation medium, and in that
the mesogenic modulation medium satisfies at least one of the following following conditions (a) and (f) and, in the case where it only satisfies condition (a) of these two conditions (a) and (f), it additionally satisfies at least one of the following conditions (b) and (c) and, in the case where it only satisfies condition (c) of conditions (b) and (c), it satisfies at least one of the two further following conditions (d) and (e), and, in the case where it satisfies condition (f), it optionally additionally satisfies condition (g),
(a) the modulation medium has, with increasing temperature, a transition from the nematic phase or from the cholesteric phase into the isotropic phase (T(N,I) or T(N*,I)), and the dielectric susceptibility of the modulation medium at a temperature of 4 degrees above the clearing point is 25 or more,
(b) the enthalpy of clearing of the modulation medium is 0.78 J/g or less, or
(c) the enthalpy of clearing of the modulation medium is 1.50 J/g or less, and
(d) the dielectric susceptibility of the modulation medium at a temperature of 4 degrees above the clearing point is 27 or more, with the proviso that light modulation elements containing modulation media which comprise 8%, 10% or 12% of compound UVZG-3-N are excluded, or
(e) the dielectric susceptibility of the modulation medium at a temperature of 4 degrees above the clearing point is 35.5 or more, with the proviso that light modulation elements containing modulation media having one of the two following compositions 1 and 2

| Composition 1 | | | Composition 2 | | |
|---|---|---|---|---|---|
| Com- | | | Com- | | |
| pound # | Abbreviation | Conc./% | pound # | Abbreviation | Conc./% |
| 1 | UZU-3A-N | 12.0 | 1 | UM-3-N | 10.0 |
| 2 | UZU-5A-N | 12.0 | 2 | PYP-3N.F.F | 15.0 |
| 3 | GZU-3A-N | 12.0 | 3 | UZU-3A-N | 12.0 |
| 4 | GZU-4A-N | 11.0 | 4 | GZU-3A-N | 12.0 |
| 5 | GZU-4O-N | 10.0 | 5 | GZU-4-N | 1.0 |
| 6 | UVZG-3-N | 10.0 | 6 | GZU-4O-N | 10.0 |
| 7 | CUZU-2-N | 10.0 | 7 | UVZG-3-N | 10.0 |
| 8 | CUZU-3-N | 10.0 | 8 | CUZU-2-N | 10.0 |
| 9 | CUZU-4-N | 10.0 | 9 | CUZU-3-N | 10.0 |
| 10 | HP-5N.F | 3.0 | 10 | HP-3N.F | 10.0 |

are excluded, where the abbreviations for the compounds are as defined in the application text,
(g) the modulation medium has, with increasing temperature, a transition from the cholesteric phase (Ch, here referred to as the chiral nematic phase N*) into a blue phase (BP) at a temperature T(N*,BP), and
(h) the dielectric susceptibility of the modulation medium at a temperature of 4 degrees above this transition temperature (T(N*,BP)) is 25 or more.

2. Light modulation element according to claim 1, characterised in that
the enthalpy of clearing of the mesogenic modulation medium is 1.10 J/g or less.

3. Light modulation element according to claim 2, characterised in that
the enthalpy of clearing of the mesogenic modulation medium is 0.70 J/g or less.

4. Light modulation element according to claim 1, characterised in that
the dielectric susceptibility of the modulation medium at a temperature of 4 degrees above the clearing point or transition temperature (T(N*,BP) is 40 or more.

5. Light modulation element according to claim 4, characterised in that
the dielectric susceptibility of the modulation medium at a temperature of 4 degrees above the clearing point or transition temperature (T(N*,BP) is 55 or more.

6. Light modulation element according to claim 1, characterised in that
the optical anisotropy at a temperature of 4 degrees below the clearing point or transition temperature (T(N*,BP) is 0.080 or more.

7. Light modulation element according to claim 1, characterised in that the mesogenic modulation medium comprises one or more compounds of the formula I 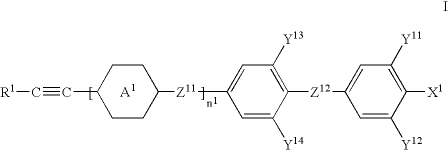
in which
R¹ denotes alkyl having 1 to 7 C atoms or oxaalkyl having 2 to 7 C atoms, 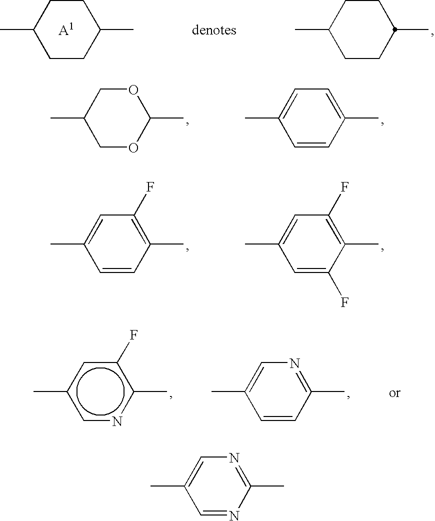
Z¹¹ and Z¹² each, independently of one another, denote a single bond, —CO—O—, trans —CH═CH—, —CH═CF—, —CF═CH—, —CF═CF—, —CH═CH—CO—O—, —CF═CF—CO—O—, —CF═CH—CO—O—, —CH═CF—CO—O—, —CF₂—O—, —O—CF₂— or —C≡C— or a combination of two or more of these groups,
X¹ denotes F, Cl, NO₂, —OCF₃, —CF₃, —OCF₂H, Cl, CN, —C≡C—CN or NCS,
Y¹¹, Y¹², Y¹³ and Y¹⁴ each, independently of one another, denote H or F and
n¹ denotes 0 or 1.

8. Light modulation element according to claim 1, characterised in that the mesogenic modulation medium comprises one or more compounds of the formula II 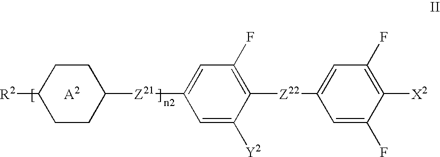
in which
R² denotes alkyl or alkoxy having 1 to 7 C atoms, alkenyl, alkenyloxy or oxaalkyl having 2 to 7 C atoms, 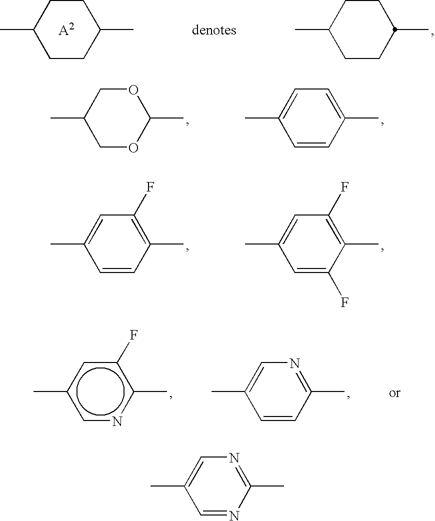
Z²¹ and Z²² each, independently of one another, denote a single bond, —CO—O—, trans —CH═CH—, —CH═CF—, —CF═CH—, —CF═CF—, —CH═CF—CO—O—, —CF₂—O—, —O—CF₂— or —C≡C— or a combination of two or more of these groups,
X² denotes F, Cl, NO₂, —OCF₃, —CF₃, —OCF₂H, Cl, CN, —C≡C—CN or NCS,
Y² denotes H or F, and
n² denotes 0 or 1.

9. Light modulation element according to claim 1, characterised in that the medium, besides the compounds of the formulae I and/or II, comprises one or more further mesogenic compounds.

10. Light modulation element according to claim 1, characterised in that the mesogenic modulation medium comprises
5% to 80 of one or more compounds of the formula I and/or
5% to 95% of one or more compounds of the formula II and/or
0% to 30% of one or more further mesogenic compounds.

11. Electro-optical display containing one or more light modulation elements according to claim 1.

12. Electro-optical display according to claim 11, characterised in that the display is addressed by means of an active matrix.

13. Electro-optical display system containing one or more electro-optical displays according to claim 11.

14. Electro-optical display system according to claim 13, characterised in that it can be used as a television screen, as a computer monitor or as both.

15. Use of a light modulation element according to claim 1 for the display of information.

16. Use of an electro-optical display according to claim 11 in an electro-optical display system.

17. Use of an electro-optical display system according to claim 13 for the display of video signals or digital signals.

18. Medium, characterised in that it satisfies the following condition (a) and at least one of the two further following conditions (b) and (c)
(a) the medium has, with increasing temperature, a transition from the nematic phase or from the cholesteric phase into the isotropic phase (T(N,I) or T(N*,I)), and the enthalpy of clearing of the medium is 1.50 J/g or less, and
(b) the dielectric susceptibility of the medium at a temperature of 4 degrees above the clearing point is 27 or more, with the proviso that media which comprise 8%, 10% or 12% of compound UVZG-3-N are excluded, or
(c) the dielectric susceptibility of the medium at a temperature of 4 degrees above the clearing point is 35.5 or more, with the proviso that media having one of the two following compositions 1 and 2

| Composition 1 | | | Composition 2 | | |
|---|---|---|---|---|---|
| Com- | | | Com- | | |
| pound # | Abbreviation | Conc./% | pound # | Abbreviation | Conc./% |
| 1 | UZU-3A-N | 12.0 | 1 | UM-3-N | 10.0 |
| 2 | UZU-5A-N | 12.0 | 2 | PYP-3N.F.F | 15.0 |
| 3 | GZU-3A-N | 12.0 | 3 | UZU-3A-N | 12.0 |
| 4 | GZU-4A-N | 11.0 | 4 | GZU-3A-N | 12.0 |
| 5 | GZU-4O-N | 10.0 | 5 | GZU-4-N | 1.0 |
| 6 | UVZG-3-N | 10.0 | 6 | GZU-4O-N | 10.0 |
| 7 | CUZU-2-N | 10.0 | 7 | UVZG-3-N | 10.0 |
| 8 | CUZU-3-N | 10.0 | 8 | CUZU-2-N | 10.0 |
| 9 | CUZU-4-N | 10.0 | 9 | CUZU-3-N | 10.0 |
| 10 | HP-5N.F | 3.0 | 10 | HP-3N.F | 10.0 |

are excluded, where the abbreviations for the compounds are as defined in the application text, or in that the medium satisfies condition (d)
(d) the modulation medium has, with increasing temperature, a transition from the cholesteric phase into a blue phase (BP) at a temperature T(N*,BP), and in that optionally the dielectric susceptibility of the modulation medium at a temperature of 4 degrees above this transition temperature is 25 or more.

19. Medium according to claim 18, characterised in that it has an enthalpy of clearing of 1.00 J/g or less.

20. Medium according to claim 19, characterised in that it has an enthalpy of clearing of 0.80 J/g or less.

21. Medium according to claim 18, characterised in that the dielectric susceptibility of the medium at a temperature of 4 degrees above the clearing point or conversion temperature is 40 or more.

22. Medium according to claim 21, characterised in that the dielectric susceptibility of the medium at a temperature of 4 degrees above the clearing point or conversion temperature is 55 or more.

23. Medium according to claim 18, characterised in that it has a clearing point or conversion temperature in the range from −30° C. to 80° C.

24. Medium according to claim 23, characterised in that it has a clearing point or conversion temperature in the range from 0° C. to 45° C.

25. Medium according to claim 18, characterised in that the optical anisotropy of the medium at a temperature of 4 degrees below the clearing point or conversion temperature is 0.080 or more.

26. Medium according to claim 18, characterised in that it comprises one or more compounds of the formula I 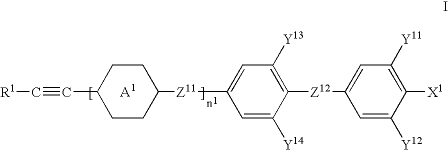
in which
R¹ denotes alkyl having 1 to 7 C atoms or oxaalkyl having 2 to 7 C atoms 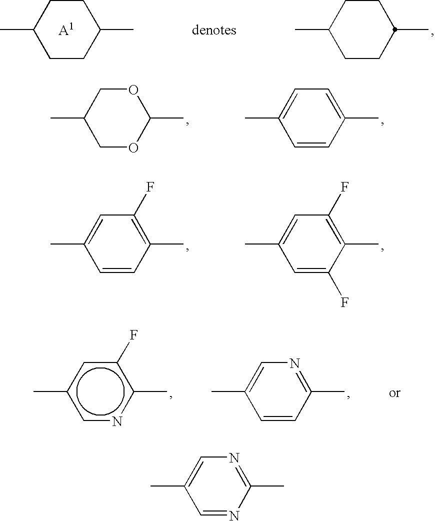
Z¹¹ and Z¹² each, independently of one another, denote a single bond, —CO—O—, trans —CH═CH—, —CH═CF—, —CF═CH—, —CF═CF—, —CH═CH—CO—O—, —CF═CF—CO—O—, —CF═CH—CO—O—, —CH═CF—CO—O—, —CF₂—O—, —O—CF— or —C≡C— or a combination of two or more of these groups,
X¹ denotes F, Cl, NO₂, —OCF₃, —CF₃, —OCF₂H, Cl, CN, —C≡C—CN or NCS,
Y¹¹, Y¹², Y¹³ and Y¹⁴ each, independently of one another, denote H or F and
n¹ denotes 0 or 1.

27. Medium according to claim 18 characterised in that it comprises one or more compounds of the formula II. 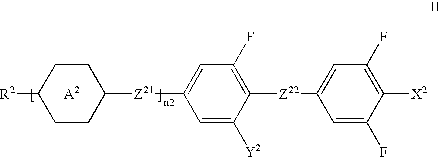
in which
R² denotes alkyl or alkoxy having 1 to 7 C atoms, alkenyl, alkenyloxy or oxaalkyl having 2 to 7 C atoms, 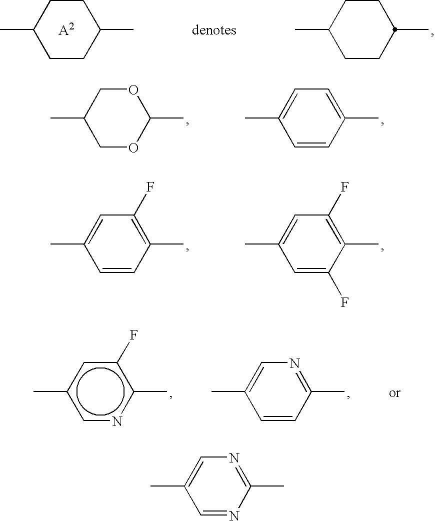
Z²¹ and Z²² each, independently of one another, denote a single bond, —CO—O—, trans —CH═CH—, —CH═CF—, —CF═CH—, —CF═CF—, —CH═CF—CO—O—, —CF₂—O—, —O—CF₂— or —C≡C— or a combination of two or more of these groups,
X² denotes F, Cl, NO, —OCF₃, CF₃, —OCF₂H, Cl, CN, —C≡C—CN or NCS,
Y² denotes H or F, and
n² denotes 0 or 1.

28. Medium according to claim 26, characterised in that, besides the compounds of the formulas I II, it comprises one or more further mesogenic compounds.

29. Medium according to claim 18, characterised in that the medium comprises
5% to 80 of one or more compounds of the formula I and/or
5% to 95% of one or more compounds of the formula II and/or
0% to 30% of one or more further mesogenic compounds.

30. Medium according to claim 27, characterised in that, besides the compounds of the formula II, it comprises one or more further mesogenic compounds.
